(19) United States
(12) Patent Application Publication
(10) Pub. No.: US 2026/0360871 A1
(43) Pub. Date: Nov. 12, 2026

(54) BATTERY CELL, BATTERY APPARATUS, POWER CONSUMING APPARATUS, AND ENERGY STORAGE APPARATUS

(71) Applicant: CONTEMPORARY AMPEREX TECHNOLOGY CO., LIMITED, Ningde (CN)

(72) Inventors: Xinde Ye, Ningde (CN); Xiaofeng Zhang, Ningde (CN); Xiaoyang Jia, Ningde (CN); Jia Li, Ningde (FJ); Tianyue Yuan, Ningde (CN); Song Li, Ningde (CN)

(21) Appl. No.: 19/392,161

(22) Filed: Nov. 18, 2025

Related U.S. Application Data
(63) Continuation of application No. PCT/CN2025/094407, filed on May 12, 2025.

(51) Int. Cl. H01M 50/105; H01M 4/02; H01M 4/136; H01M 4/36; H01M 4/58; H01M 4/62; H01M 10/0525; H01M 10/0569; H01M 50/184; H01M 50/426; H01M 50/434; H01M 50/457

(52) U.S. Cl. CPC H01M 50/105; H01M 4/136; H01M 4/366; H01M 4/5825; H01M 4/623; H01M 4/625; H01M 10/0525; H01M 10/0569; H01M 50/184; H01M 50/426; H01M 50/434; H01M 50/457; H01M 2004/021; H01M 2300/004

(57) ABSTRACT

A battery cell, a battery apparatus, a power consuming apparatus, and an energy storage apparatus are disclosed. The battery cell includes a stacked electrode assembly housed in a pouch-type material. The housing has a first sealing zone at one end of the stacked electrode assembly along a width direction, the sealing zone including a double-folded edge structure secured by a sealing adhesive continuously disposed along a length direction. The stacked electrode assembly includes a positive electrode plate, a negative electrode plate, and an electrolyte. The positive electrode plate has a current collector and a film layer containing lithium-containing transition metal phosphate particles, at least partly coated with carbon. In a cross-section, 12-50% of particles have a size ≥1000 nm, the film layer thickness is 70-120 μm, and the compaction density is 2.3-2.6 g/cm³. The electrolyte contains dimethyl carbonate in an amount of 18-32% by mass.

### CROSS-REFERENCE TO RELATED APPLICATIONS

The present application is a continuation of International Application No. PCT/CN2025/094407, filed on May 12, 2025, which is incorporated herein by reference in its entirety.

### TECHNICAL FIELD

This application relates to the field of battery technologies, and in particular, to a battery cell, a battery apparatus, a power consuming apparatus, and an energy storage apparatus.

### BACKGROUND

In recent years, battery cells have been widely used in energy storage power supply systems such as water power stations, thermal power stations, wind power stations, and solar power stations, and in a plurality of fields such as electric tools, electric bicycles, electric motorcycles, electric vehicles, military equipment, and aerospace.

With the simultaneous elevation of national/industry standards and market demands for the capacity and reliability of power consuming apparatuses, higher requirements are imposed on battery cells. However, existing technologies struggle to achieve simultaneous improvement in these performance aspects, presenting an urgent technical challenge in the field.

### SUMMARY

In view of the foregoing problem, this application provides a battery cell, a battery apparatus, a power consuming apparatus, and an energy storage apparatus. Details are described below.

A first aspect of this application provides a battery cell, including a stacked electrode assembly and a housing, where the stacked electrode assembly is accommodated in the housing, and the housing is made of a pouch-type material; the housing includes a first sealing zone, and the first sealing zone is disposed at at least one end of the stacked electrode assembly extending along a width direction; the first sealing zone includes a double-folded edge structure extending along a length direction, a sealing adhesive is disposed on the double-folded edge structure, and the sealing adhesive is continuously disposed in the length direction and secures the double-folded edge structure; the stacked electrode assembly includes a positive electrode plate, a negative electrode plate, and an electrolyte, the positive electrode plate includes a positive electrode current collector and a positive electrode film layer disposed on at least one side of the positive electrode current collector, the positive electrode film layer includes lithium-containing transition metal phosphate particles, and at least a portion of a surface of the lithium-containing transition metal phosphate particles is provided with a carbon material; based on a total area of particles in a cross-section of the positive electrode film layer in a thickness direction of the positive electrode plate, an area percentage of particles whose particle size R1 meets R1≥1000 nm ranges from 12% to 50%; a single-side thickness of the positive electrode film layer is denoted as H, and H ranges from 70 μm to 120 μm; when the battery cell is in a fully-discharged state, a compaction density of the positive electrode plate ranges from 2.3 g/cm³ to 2.6 g/cm³; and the electrolyte includes a solvent, and the solvent includes dimethyl carbonate (DMC); and based on a total mass of the electrolyte, a mass percentage of dimethyl carbonate ranges from 18% to 32%.

Lithium-containing transition metal phosphates all have relatively low gram capacities. Research shows that when the single-side thickness H of the positive electrode film layer is less than 70 μm, the battery capacity struggles to meet market demand. In the embodiments of this application, the single-side thickness H of the positive electrode film layer is controlled within the range of 70 μm to 120 μm, which is conducive to increasing the space utilization of active materials, and a casing of a pouch-type material is further used, thereby reducing the weight of the battery cell, and improving the gravimetric energy density of the battery. However, the thick positive electrode film layer undergoes significant volume changes due to lithium intercalation and lithium deintercalation during charge-discharge cycles, leading to the accumulation of mechanical stress, and further causing the expansion and contraction of electrode materials. The electrode plates exhibit springback and an increase in thickness, causing an increase in mechanical stress in an encapsulation structure. In addition, the thick film layer means more difficult conduction of internal heat and proneness to local overheating, which aggravates side reactions and gas generation of the electrolyte, thereby further increasing the internal pressure of the battery cell. Compared with a wound structure, the structure of the stacked electrode assembly reduces void spaces, thereby improving the volumetric energy density. However, the stacked electrode assembly lacks the restraining effect provided by the wound structure and offers limited suppression of springback in the thick-coating film layer, resulting in degraded reliability of the battery cell. Compared with hard shell materials, the pouch-type material exhibits lower mechanical strength and reduced capability to withstand internal pressure. In addition, the pouch-type material exhibits lower thermal conductivity, which may lead to easier heat accumulation inside the battery cell, further exacerbating gas generation issues. During long-term use, excessive internal pressure may rupture the sealing zone.

In the embodiments of this application, the first sealing zone includes the double-folded edge structure extending along a long-side direction, thereby further improving the sealing strength of the first sealing zone. The double-folded edge folds and encapsulates the pouch-type material of the housing twice, thereby forming a multi-layered sealing barrier. Even if the first-layer folded edge structure develops a defect due to springback stress from the high thickness of the positive electrode film layer in the electrode assembly and the gas generation of the electrolyte, the second-layer folded edge structure can still remain sealed. In addition, because the pouch-type material is thermally fused and bonded during battery processing, the double-folded edge can make the thermally-sealed region more uniform, thereby mitigating inadequate sealing in localized regions. The sealing junction is a vulnerable link in the mechanical strength of the pouch-type electrode assembly, thereby further enhancing the reliability of encapsulation. The inventor arranges the sealing adhesive on the double-folded edge structure. The sealing adhesive is continuously disposed in the long-side direction and secures the double-folded edge structure, and may cover microcracks or defects of the thermally-sealed region in the sealing zone of the pouch-type material. In addition, the double-folded edge structure retains particular elastic memory after thermal sealing, and may spring back after long-term use. The sealing adhesive may secure the double-folded edge structure, thereby maintaining the stability of the structure. In the embodiments of this application, when the battery cell is in the fully-discharged state, the compaction density of the positive electrode plate may be further controlled to range from 2.3 g/cm³ to 2.6 g/cm³, so that in one aspect, the battery cell has high capacity, and in another aspect, a particular cushioning space is provided between particle accumulation structures, thereby reducing stress applied on the encapsulation structure by the springback of the electrode plate. To further reduce the stress inside the battery cell, the inventor regulates the area percentage of the particles whose particle size R1 meets R1≥1000 nm in the positive electrode film layer and the mass percentage of dimethyl carbonate in the electrolyte. The inventor finds that with the same expansion rate, compared with large particles, it is easier for the expansion of small particles to be absorbed by tiny pore structures between particles. Large particles exhibit large absolute expansion changes, and are more difficult to be dissipated. When the area percentage of the particles whose particle size R1 meets R1≥1000 nm is greater than 50%, stress concentration tends to occur, and distinct springback occurs, resulting in an increase in the internal pressure of the battery cell. When the area percentage of the particles whose particle size R1 meets R1≥1000 nm is less than 12%, the optimization of the particle size distribution and compaction density of the positive electrode film layer are restricted, failing to effectively improve the battery capacity. Therefore, the area percentage of the particles whose particle size R1 meets R1≥1000 nm is controlled to range from 12% to 50%, which is conducive to further improving the reliability of the battery cell while maintaining energy density. Dimethyl carbonate has multiple advantages such as low viscosity, excellent low-temperature performance, and low costs. When the mass percentage of dimethyl carbonate in the electrolyte is lower than 18%, it is difficult to constitute a low-viscosity system, and it is difficult to increase the overall ion conductivity of the electrolyte, which causes an increase in the ohmic impedance inside the battery, leading to increased Joule heat. Chain carbonate exhibits weak oxidation resistance, and the symmetric structure of dimethyl carbonate is more prone to decomposition in a high-voltage or high-temperature environment. When the mass percentage of dimethyl carbonate is higher than 32%, gas generation is severe in long cycling, resulting in an increase in a probability of an encapsulation failure. The mass percentage of dimethyl carbonate in the electrolyte is controlled to range from 18% to 32%, so that a balance can be achieved between the low viscosity and the gas generation risk of the electrolyte. The foregoing technical measures collaborate to further achieve a balance between the energy density and the reliability of the battery.

In any embodiment, the single-side thickness of the positive electrode film layer is denoted as H, and H ranges from 90 μm to 120 μm, and optionally ranges from 100 μm to 120 μm.

The single-side thickness of the positive electrode film layer is within the foregoing range, which is conducive to further improving energy density. The applicant finds that when the single-side thickness of the positive electrode film layer is greater than 100 μm, the positive electrode plate exhibits a more severe springback phenomenon. In the embodiments of this application, through the double-folded edge structure of the first sealing zone, the structural strength of the housing is increased, thereby reducing a probability that sealing is ruptured due to internal stress from the springback of the film layer, so that the reliability of the battery is enhanced while high energy density is maintained.

In any embodiment, the housing includes at least one second sealing zone, the second sealing zone is disposed at at least one end of the stacked electrode assembly in the length direction of the housing, and the second sealing zone is disposed on a tab side of the stacked electrode assembly.

The second sealing zone is disposed on the tab side. The tab and a terminal need to be connected to each other. The connection strength between the terminal and the housing material is relatively weak, making it easy for gas to vent through the second sealing zone, which is conducive to achieving directional pressure relief for the battery, thereby reducing the impact on an adjacent electrode assembly when sealing fails, and improving the overall safety and reliability of a battery apparatus.

In any embodiment, an outer periphery of the stacked electrode assembly is provided with a plurality of adhesive rings surrounding along the width direction, and the adhesive rings surrounding along the width direction are disposed at intervals in the length direction.

The adhesive rings surrounding along the width direction of the electrode assembly are arranged at intervals in the length direction, which is conducive to increasing the restraining force on the electrode assembly, and is especially applicable to a battery cell having a thick-coating film layer, so that the springback rate of the positive electrode film layer and the springback pressure on the sealing zone can be effectively reduced, thereby further reducing a probability of a failure in the sealing zone, and improving the reliability of the battery cell.

In any embodiment, based on the total area of particles in the cross-section of the positive electrode film layer in the thickness direction of the positive electrode plate, the area percentage of particles whose particle size R1 meets R1≥1000 nm ranges from 12% to 37%.

When the area percentage of the particles whose particle size R1 meets R1≥1000 nm is within the foregoing range, an expansion force applied on the pouch-type material and the sealing zone by the springback of large particles is further reduced, thereby improving the reliability of the battery cell.

In any embodiment, in the cross-section of the positive electrode film layer in the thickness direction of the electrode plate, in an area-weighted cumulative distribution curve of sphericity of particles whose particle size R1 meets R1≥1000 nm, a median L_{R1A50} of sphericity ranges from 0.6 to 0.8, optionally ranges from 0.65 to 0.75, and further optionally, ranges from 0.67 to 0.75.

In the area-weighted cumulative distribution curve of sphericity of the particles whose particle size R1 meets R1≥1000 nm, L_{R1A50} is within the foregoing range. The particles exhibit a more ideal spherical morphology and are easily rollable, so that volume changes caused by the springback of the thick positive electrode film layer or charge-discharge expansion can be accommodated through the rearrangement of packing configurations within a particular space range, thereby reducing the burden on the first sealing zone, and improving the reliability of the battery cell.

In any embodiment, in the cross-section of the positive electrode film layer in the thickness direction of the electrode plate, a distribution uniformity of particles whose particle size R1 meets R1≥1000 nm is less than or equal to 5%, optionally ranges from 0.2% to 2%, and further optionally, ranges from 0.2% to 0.9%.

The distribution uniformity of the particles whose particle size R1 meets R1≥1000 nm in the cross-section of the positive electrode film layer in the thickness direction of the electrode plate is within the foregoing range, so that the stress concentration degrees in localized regions in the film layer can be effectively reduced, and the springback stress in the cycling process of the thick-coating film layer can be uniformly dispersed in the entire region of the film layer to reduce the springback rate of the positive electrode film layer, thereby reducing a probability of a failure of the encapsulation structure while improving the energy density of the battery, and improving the reliability of the battery.

In any embodiment, the solvent in the electrolyte further includes one or two of ethyl methyl carbonate (EMC) and ethylene carbonate (EC).

In any embodiment, based on the total mass of the electrolyte, a mass percentage of ethyl methyl carbonate (EMC) ranges from 39% to 49%.

At 25 °C, ethyl methyl carbonate (EMC) has a viscosity of 0.65 mPa s, which is higher than that of DMC but less than that of EC, and still maintains excellent flowability at a low temperature, so that EMC and DMC jointly achieve the function of reducing the overall viscosity of the electrolyte, thereby improving the migration rate of lithium ions in the electrolyte, and reducing Joule heat. In addition, compared with DMC, EMC has higher oxidative stability and thermal stability, thereby further reducing the decomposition and gas generation of the electrolyte, and improving the reliability of the battery cell.

In any embodiment, based on the total mass of the electrolyte, a mass percentage of ethylene carbonate (EC) ranges from 13% to 22%.

Ethylene carbonate (EC) has an exceptionally high dielectric constant, which enables effective dissolution of lithium salts, thereby improving the ion conductivity of the electrolyte, and ensuring the smooth migration of lithium ions. EC within the mass percentage range can decompose on the surface of a negative electrode active material and form a stable SEI film, thereby reducing side reactions, and improving the cycle life.

In any embodiment, based on the total mass of the electrolyte, a total mass percentage of ethyl methyl carbonate (EMC) and ethylene carbonate (EC) ranges from 52% to 71%.

The total mass content of EC and EMC is within the foregoing range, and the complementary combination of EC and EMC overcomes the problems that the viscosity of EC is high and the SEI film formed by EMC has poor thermal stability and mechanical strength, thereby achieving the optimization of the performance of the electrolyte, and further reducing the pressure of Joule heat and the decomposition and gas generation of the SEI film on the sealing zone in the direction of optimizing the ion conductivity and the SEI film.

In any embodiment, the electrolyte includes an electrolyte salt, the electrolyte salt includes lithium hexafluorophosphate (LiPF₆), and a concentration of lithium hexafluorophosphate in the electrolyte ranges from 0.9 mol/L to 1.2 mol/L.

Lithium hexafluorophosphate (LiPF₆) can highly dissolve in carbonate-based solvents to form a high-concentration electrolyte, thereby ensuring the high ion conductivity of lithium ions in the electrolyte. In addition, a low-potential negative electrode can induce the stable formation of the SEI film, and reduce lithium deposition, thereby improving the cycle life. The concentration of lithium hexafluorophosphate is excessively high, and the viscosity of the electrolyte is clearly increased, leading to limited diffusion of lithium ions, and the ion conductivity is decreased. In addition, decomposition results of lithium hexafluorophosphate includes PF₅, which further reacts with a slight amount of water in the electrolyte to generate HF, and further corrode the electrode and the SEI film, thereby aggravating the decomposition and gas generation of the solvent. The concentration of lithium hexafluorophosphate is within the foregoing range, so that an optimal balance can be achieved among the aspects such as the ion conductivity and the stability of the electrolyte.

In any embodiment, based on the total mass of the electrolyte, a mass percentage of dimethyl carbonate ranges from 18% to 26%.

The mass percentage of dimethyl carbonate is within the foregoing range, and EC and EMC with higher percentages are introduced, to further reduce the capability and probability of gas generation of the electrolyte, thereby improving the long-term reliability of the battery cell.

In any embodiment, in a cumulative distribution curve of a graphitization degree C value obtained from the positive electrode film layer in an area mapping mode of a laser microscopic confocal Raman spectrometer, a median C₅₀ of the graphitization degree ranges from 0.95 to 1.20, the graphitization degree C value is I_{G}/I_{D}, I_{G} represents the intensity of the G band at 1580±100 cm⁻¹ in Raman spectra, and I_{D} represents the intensity of the D band at 1350±100 cm⁻¹ in Raman spectra.

Research shows that the stress in the film layer extremely easily leads to an increase in the internal mechanical pressure under the effect of cyclic expansion, causing a failure in the encapsulation structure. The median C₅₀ of the graphitization degree in the cumulative distribution curve of the graphitization degree C value obtained from the positive electrode film layer in the area mapping mode of the laser microscopic confocal Raman spectrometer is controlled to range from 0.95 to 1.20, so that the graphitization degree of the positive electrode film layer is improved, the slip propensity of particles in the positive electrode film layer is improved, the phenomenon of stress concentration in the compaction process of the thick-coating film layer is reduced, and the degree of springback of the positive electrode film layer due to localized stress concentration during cycling is reduced, thereby improving the reliability of the battery cell while increasing the volumetric energy density of the battery cell.

In any embodiment, in a cumulative distribution curve of a coating value B obtained from the positive electrode film layer in the area mapping mode of the laser microscopic confocal Raman spectrometer, a median B₅₀ of the coating value ranges from 0.30 to 0.60, the coating value B is I_{P}/I_{D}, I_{P} represents the intensity of the P band at 948±100 cm⁻¹ in Raman spectra, and I_{D} represents the intensity of the D band at 1350±100 cm⁻¹ in Raman spectra.

The median B₅₀ of the coating value of the positive electrode film layer is within the foregoing range, indicating that the carbon material on the surface of the positive electrode active material is dense and uniform, which is conducive to improving the slip uniformity of the positive electrode film layer in a rolling process, thereby reducing the phenomenon of stress concentration in the positive electrode film layer, reducing the degree of springback of the positive electrode plate, and improving the reliability of the battery cell.

In any embodiment, the lithium-containing transition metal phosphate particles include iron, and an iron dissolution rate of the positive electrode film layer ranges from 658 ppm to 1921 ppm, and optionally ranges from 658 ppm to 1485 ppm.

Iron dissolved from the positive electrode film layer mainly comes from the lithium-containing transition metal phosphate of the positive electrode active material, and the magnitude of the iron dissolution rate depends on the number of lattice defects of the lithium-containing transition metal phosphate in one aspect, and depends on the integrity and density of the carbon material on the surface of the positive electrode active material in another aspect. When the iron dissolution rate is lower, the lithium-containing transition metal phosphate has fewer lattice defects, which is conducive to reducing the corrosion of lattices in a weak acid environment. In addition, when the carbon material on the surface of the positive electrode active material is more complete and denser, the dissolution of iron ions in a weak acid environment is inhibited. The positive electrode film layer with the iron dissolution rate falling within the foregoing range has a relatively small number of lattice defects, and the surface of the positive electrode active material has a complete and dense carbon material, which is conducive to improving the compression resistance and the slip propensity of the particles in the positive electrode film layer under large rolling pressure, thereby improving the compaction density of the positive electrode film layer and reducing the stress concentration in the positive electrode film layer, and improving the energy density of the battery while improving the reliability of the battery.

In any embodiment, the positive electrode film layer further includes a conductive agent, and based on a total area of the cross-section of the positive electrode film layer in the thickness direction of the electrode plate, a total area percentage of agglomeration regions of the conductive agent ranges from 0.5% to 2.5%, and optionally ranges from 0.5% to 1.7%.

The total area percentage of agglomeration regions of the conductive agent based on the total area of the cross-section of the positive electrode film layer in the thickness direction of the electrode plate ranges from 0.5% to 2.5%, indicating that the conductive agent in the positive electrode film layer is dispersed uniformly, which facilitates the formation of a uniform conductive network, and is especially conducive to mitigating the problem of kinetic degradation resulting from an elongated ion transport path in the thick-coating film layer, thereby mitigating localized polarization and even lithium plating issues of the battery during cycling. In addition, research shows that large-dimension particles in the lithium-containing transition metal phosphate particles are prone to springback. When the agglomeration area of the conductive agent is within the foregoing range, the uniform distribution of the conductive agent can inhibit the springback of lithium-containing transition metal phosphate, and mechanical restraining is formed for the particles and even the film layer to improve the cohesive force of the film layer, thereby reducing the probability that the sealing zone fails, and improving the reliability of the battery.

In any embodiment, the conductive agent includes carbon nanotubes, and the carbon nanotubes include one or more of single-walled carbon nanotubes, few-walled carbon nanotubes, and multi-walled carbon nanotubes.

Carbon nanotubes have the structural characteristic of a high length-diameter ratio, which is conducive to forming a long-range conductive path between a plurality of positive particles lapped in the thickness direction and improving the restraining force between particles, so that the kinetic performance of the thick-coating positive electrode film layer is improved to mitigate localized polarization and even lithium plating issues of the battery during cycling, thereby improving the cycle life of the battery, and a network structure can be formed in the positive electrode film layer for use as a bridge for stress propagation to effectively mitigate stress concentration and reduce the degree of springback of the electrode plate, thereby improving the reliability of the battery cell. In addition, carbon nanotubes have a high specific surface area and a hollow structure, thereby further providing an excellent liquid retention capability. A thick electrode plate has a large expansion force during cycling, making the electrolyte easy to be extruded, and carbon nanotubes are conducive to improving the liquid retention capability of the thick electrode plate in the positive electrode film layer, thereby mitigating a capacity cliff of the battery cell during cycling, and improving the cycle life of the battery cell.

In any embodiment, the conductive agent further includes conductive carbon black.

Conductive carbon black has a high specific surface area, thereby further providing an excellent liquid retention capability. A thick electrode plate has a large expansion force during cycling, making the electrolyte easy to be extruded, and the distribution of conductive carbon black in the positive electrode film layer is conducive to improving the liquid retention capability of the thick electrode plate, thereby mitigating a capacity cliff of the battery during cycling, and improving the cycle life of the battery.

In any embodiment, the agglomeration regions of the conductive agent include carbon nanotubes and conductive carbon black.

Researchers find that carbon nanotubes are prone to an agglomeration phenomenon due to the high surface energy of carbon nanotubes. As a result, the dispersion of carbon nanotubes in the positive electrode film layer is nonuniform, and an effective network structure of carbon nanotubes fails to be formed. Conductive carbon black has surface energy close to that of carbon nanotubes and can be adsorbed on the surface of carbon nanotubes to form a physical barrier, to increase the resistance against the agglomeration of carbon nanotubes and reduce direct contact between carbon nanotubes, thereby further inhibiting the agglomeration phenomenon and improving the distribution uniformity of carbon nanotubes in the positive electrode film layer. This is conducive to improving the conductivity of the thick-coating positive electrode film layer in one aspect, thereby improving the kinetic performance of the battery, and is conducive to exerting the function of restraining carbon nanotubes on the positive electrode film layer in another aspect, thereby reducing the risk that the thick-coating positive electrode film layer falls off, and further improving the kinetic performance and cycle life of the battery. In addition, the agglomeration of carbon nanotubes in the agglomeration regions of the conductive agent further leads to congestion in a localized ion transport path in the agglomeration regions of the conductive agent, and the combination with conductive carbon black can improve the lithium ion transport capability in the region, thereby reducing localized polarization, and further improving the cycle stability of the battery.

In any embodiment, based on a mass of the positive electrode film layer, a mass content C1 of the carbon nanotubes meets: 0<C1≤2.5%, and a mass content C2 of the conductive carbon black meets: 0<C1≤2.5%.

The mass contents of carbon nanotubes and conductive carbon black in the positive electrode film layer fall within the foregoing ranges, so that the agglomeration phenomenon of carbon nanotubes can be effectively mitigated and an excellent conductive network structure can be formed, to effectively alleviate stress concentration in the positive electrode film layer, thereby improving the reliability of the battery cell; and the liquid retention rate of the positive electrode plate during long cycling is increased to reduce a polarization degree, thereby mitigating the capacity cliff issue of the battery cell.

In any embodiment, the positive electrode film layer further includes a dispersant, and the dispersant includes hydrogenated nitrile butadiene rubber HNBR.

HNBR is obtained by hydrogenating butyronitrile rubber to saturate the double bonds. The highly saturated backbone structure of HNBR provides excellent oil resistance, heat resistance, aging resistance, and the like. This enables HNBR to maintain stability as a dispersant in diverse environments and systems, resisting degradation or deterioration while effectively performing the dispersion function. The HNBR molecular chain contains both polar nitrile groups and nonpolar hydrocarbon segments. The polar nitrile groups can interact with hydroxyl groups (—OH) or metal oxide sites on the surface of lithium-containing transition metal phosphate particles (for example, through hydrogen bonding or dipole interactions), enhancing particle-solvent compatibility and reducing interfacial tension between the particles and the solvent, especially interfacial tension with large particles, so that the uniform dispersion of the particles are promoted, aggregation caused by hydrophobicity is reduced, and the dispersion of large particles in the positive electrode film layer is improved, thereby reducing stress concentration induced by springback. The nonpolar hydrocarbon segments have excellent lipophilicity, enabling excellent extension and dispersion in nonpolar or weakly polar media, thereby facilitating uniform dispersion of particles in the media. After HNBR is adsorbed on the surface of particles in slurry, the long-chain molecules of HNBR form a physical barrier layer around the particles to keep the particles from approaching each other and aggregating, thereby maintaining a relatively independent dispersed state of the particles in the system. In addition, HNBR can reduce the surface tension between the dispersion media and the dispersed particles, making the particles easier to be wetted by the media, thereby promoting the dispersion of the particles in the media. In addition, the interfacial energy between particles, especially, the aggregation phenomenon of the conductive agent driven by interfacial energy, can be further reduced, thereby improving the cycle life of the battery cell.

In any embodiment, based on the mass of the positive electrode film layer, a mass content of the dispersant ranges from 0.5% to 2%.

The mass content of the dispersant is within the foregoing range, so that the uniform dispersion of particles in the positive electrode film layer can be achieved while maintaining the high load amount of the positive electrode film layer, to mitigate springback caused by stress concentration in the positive electrode film layer of the thick-coating lithium-containing transition metal phosphate, thereby reducing the springback rate of the positive electrode film layer, and improving the reliability of the battery cell.

In any embodiment, a porosity of the positive electrode film layer ranges from 14% to 28%.

The porosity of the positive electrode film layer is within the foregoing range, so that in one aspect, the liquid retention characteristic of the electrolyte is improved, and the ionic diffusibility of the thick-coating electrode plate and positive electrode film layer is improved, thereby improving the kinetic performance of the battery, and in another aspect, springback or a volume increase in a charge-discharge process can be cushioned to reduce the impact of the expansion stress on the sealing zone, thereby maintaining the high reliability of the battery.

In any embodiment, the battery cell further includes a separator disposed between the positive electrode plate and the negative electrode plate, the separator includes a base film, a ceramic layer disposed on each of two sides of the base film, and a bonding layer disposed on at least one side of the ceramic layer away from the base film, the bonding layer is a continuous layer with a porous structure, and the bonding layer includes a vinylidene fluoride-based polymer.

The separator provided in the embodiments of this application uses the continuous layer with the porous structure as the bonding layer, which has a larger bonding area compared with a bonding layer in existing technologies, so that the bonding between the separator and the positive electrode film layer is more secure and uniform. The particles whose particle size R1 meets R1≥1000 nm is prone to stress concentration during cycling to cause springback issues. The separator provided in the embodiments of this application uses the continuous layer with the porous structure as the bonding layer, and is especially applicable to a thick-coating stacked electrode assembly, to mitigate the springback phenomenon of the thick-coating stacked electrode assembly during long cycling, thereby reducing the expansion stress inside the battery, and improving the overall reliability of the sealing zone and the battery cell. Additionally, the thick-coating electrode assembly is prone to a relative displacement between the electrode plate and the separator in a process of dragging an outer-layer electrode plate and soldering a tab, so that the film layer is prone to powder falling or even lapping between the positive and negative electrodes to cause the risk of an internal short-circuit. The use of the continuous layer with the porous structure in the embodiments of this application as the bonding layer can also lower the foregoing risk.

In any embodiment, a base coating layer is disposed in a bottom region of the positive electrode film layer close to the positive electrode current collector, and the base coating layer meets at least one of the following conditions: (1) the base coating layer includes a conductive agent and a binder, the conductive agent includes carbon nanotubes and conductive carbon black, and the binder includes a vinylidene fluoride polymer; and (2) a thickness of the base coating layer ranges from 0.5 μm to 5 μm.

The base coating layer provided in the embodiments of this application is conducive to improving the bonding force between the positive electrode film layer and the positive electrode current collector and mitigating the phenomenon of stress concentration at large particles, thereby reducing the springback of the positive electrode film layer, and improving the reliability of the battery cell. In addition, compared with the direct contact between the positive electrode current collector and the positive electrode film layer, the contact area between the base coating layer and the positive electrode film layer is increased, which is conducive to increasing an electron transport area between the current collector and the positive electrode film layer, thereby reducing the internal resistance of the electrode plate, and improving the kinetic performance of the battery.

In any embodiment, the lithium-containing transition metal phosphate particles in the positive electrode film layer include a component shown in the following general formula: LiₘFeₓP_{y}OⱼQ_{q} Formula I, where Q includes one or more of Al, Na, K, Mg, Cu, Mn, Cr, Zn, Pb, Ca, Co, Ni, Sr, Nb, V, Ti, B, S, Si, N, F, Cl, and Br, 0.8≤m≤1.15, 0.9≤x≤1, 0.95≤y≤1, 3.5≤j≤4, and 0≤q≤0.1.

The selection of a suitable modification element Q can improve a lattice change rate of the positive electrode active material in a lithium deintercalation and intercalation process and reduce the oxygen reactivity on the surface of the particles, to improve the structural stability of the material, thereby further improving the specific capacity utilization of the material during cycling, and improving the cycle stability of the battery cell.

In any embodiment, the lithium-containing transition metal phosphate particles include titanium, and based on a total mass of the lithium-containing transition metal phosphate particles in the positive electrode film layer, a mass content of titanium ranges from 500 ppm to 8000 ppm, and optionally ranges from 1000 ppm to 3000 ppm.

To introduce titanium into the lithium-containing transition metal phosphate particles, a titanium source needs to be added in a process of preparing the positive electrode active material. The titanium source is usually an inert material, and can achieve the functions of reducing reactivity and suppressing particle dimension growth after being adhered to the surface of lithium-containing transition metal phosphate precursors. To improve the graphitization degree of the positive electrode active material, high sintering temperatures or long sintering durations are usually required. However, this also increases the dimensions of the particles in the positive electrode film layer and increases stress concentration of the positive electrode film layer, leading to the falling off of the positive electrode film layer. In the embodiments of this application, high-content titanium is added to the lithium-containing transition metal phosphate particles, so that the reactivity of synthetic precursors of the positive electrode active material are reduced, and the percentage of large particles is controlled while the positive electrode active material has a high graphitization degree, to reduce the springback rate of the positive electrode film layer, thereby improving the energy density of the battery while maintaining the reliability of the battery. In addition, the doping of titanium in the positive electrode active material is conducive to inducing lattice distortion and reducing Li—O bond energy, thereby increasing the transport rate of lithium ions, and improving the kinetic performance of the battery. The diffusion of lithium ions in the thick-coating film layer is not uniform, and is usually accompanied with a significant lithium ionic concentration gradient. In the embodiments of this application, high-content titanium is added to the lithium-containing transition metal phosphate particles to increase a solid-phase transport rate of the positive electrode active material, thereby mitigating the kinetic issues of the battery with the thick electrode plate.

In any embodiment, the lithium-containing transition metal phosphate particles include vanadium, and based on the total mass of the lithium-containing transition metal phosphate particles in the positive electrode film layer, a mass content of vanadium ranges from 500 ppm to 5000 ppm, and optionally ranges from 500 ppm to 3000 ppm.

Vanadium in the positive electrode film layer can exist in multiple valence states. Pentavalent vanadium (V⁵⁺) can be doped at phosphorus sites, and can induce lattice distortion due to its large radius, expanding lithium-ion diffusion channels, thereby improving the ion conductivity of the positive electrode active material, and improving the kinetic performance of the battery. Trivalent vanadium (V³⁺) may be doped at transition metal sites, generating lithium vacancies through charge compensation, thereby improving the electron conductivity of the positive electrode active material. In addition, the distribution uniformity of vanadium in the lithium-containing transition metal phosphate particles is improved, which is conducive to further improving the kinetic performance of the positive electrode film layer and the reaction uniformity of the positive electrode film layer, thereby improving the kinetic performance and the cycle performance of the battery cell. The mass content of vanadium is within the foregoing range, which is conducive to improving the kinetic performance of the positive electrode plate, thereby improving the kinetic performance of the battery with thick-coating lithium-containing transition metal phosphate. In addition, the collaboration of titanium, vanadium, and carbon nanotubes in the positive electrode film layer is conducive to forming an excellent three-dimensional network, to further improve the electron conductivity and the ion conductivity of the positive electrode film layer, thereby further improving the kinetic performance of the battery with thick-coating lithium-containing transition metal phosphate.

In any embodiment, the pouch-type material includes an aluminum laminate composite film, and optionally, includes a composite film formed by aluminum and one or more of aluminum, polypropylene (PP), polybutylene terephthalate (PBT), polybutylene succinate (PBS), nylon, polyethylene terephthalate (PET), and polyethylene (PE).

In any embodiment, at least one stacked electrode assembly is accommodated in the housing, a dimension of the housing in the length direction is L₀, a dimension of the housing in the width direction is W₀, a dimension of the housing in the thickness direction is H₀, 450 mm≤L₀≤1300 mm, 100 mm≤W₀≤150 mm, and 14 mm≤H₀≤22 mm.

In any embodiment, the dimension L₀ of the housing in the length direction meets: 450 mm≤L₀≤650 mm.

When the dimension L₀ of the housing in the length direction meets 450 mm L₀ 650 mm, the length of the battery cell is small, which is conducive to shortening a diffusion path for current, to reduce the internal resistance of the electrode plate, thereby reducing the heat generation of the battery and improving the kinetic performance of the battery. In addition, the small length of the housing is conducive to shortening a diffusion path for the electrolyte during infiltration, to increase the infiltration rate and uniformity of the electrolyte, thereby further promoting deintercalation and intercalation uniformity of lithium ions during cycling, mitigating the phenomenon of stress concentration, reducing the extent of springback of the film layer, and improving the reliability of the battery cell.

When the dimension L0 of the housing in the length direction meets 450 mm≤L0≤650 mm, the length of the battery cell is small, which is conducive to shortening a transport path for electrons, to reduce the internal resistance of the battery, and also reduce an infiltration distance of the electrolyte in the electrode pores, increasing the uniformity of infiltration, thereby improving the kinetic performance of the thick-coating film layer. Nonuniform temperature rise and nonuniform current density of the electrode plate in the length direction can be reduced especially under fast charging conditions.

In any embodiment, the dimension L₀ of the housing in the length direction meets: 900 mm L₀ 1300 mm.

When the dimension L₀ of the housing in the length direction meets 900 mm L₀ 1300 mm, the dimension of the battery cell is large, which is conducive to reducing the volume percentage of the housing in the battery cell, thereby increasing the load percentage of the active material. In addition, the long battery cell can reduce the number of batteries required in a battery module, to simplify the structural design of the battery module, and reduce the number and complexity of the structural members in the module, thereby improving the space utilization of a battery pack, and further increasing the volumetric energy density of the battery cell.

In any embodiment, at 25 °C, a capacity of the battery cell ranges from 105 Ah to 300 Ah, and optionally ranges from 150 Ah to 190 Ah.

A second aspect of this application provides a battery apparatus, including the battery cell according to the first aspect of this application.

A third aspect of this application provides a power consuming apparatus, including the battery apparatus according to the second aspect, and the battery apparatus is configured to supply electric energy.

A fourth aspect of this application provides an energy storage apparatus, including the battery apparatus according to the second aspect, and the battery apparatus is configured to store electric energy.

### BRIEF DESCRIPTION OF THE DRAWINGS

FIG. 1 is a front view of a battery cell according to an embodiment of this application;

FIG. 2 is a schematic diagram of a separator according to an embodiment of this application;

FIG. 3 is a schematic diagram of a separator in existing technologies; and

FIG. 4 is a schematic diagram of a power consuming apparatus according to an embodiment of this application.

5. battery cell; 50. housing; 51. first sealing zone; 52. second sealing zone; 53. terminal; 20. separator; 201. base film; 202. ceramic layer; 203. bonding layer; X. length direction; Y. width direction; and Z. thickness direction.

### DETAILED DESCRIPTION

Hereinafter, embodiments of an electrolyte solution, a battery cell, a battery apparatus, a power consuming apparatus, and an energy storage apparatus of this application are specifically disclosed in the detailed description with appropriate reference to the accompanying drawings. However, there may be situations where unnecessary detailed explanations are omitted. For example, there are situations where detailed explanations of well-known matters are omitted and repeated explanations of the same structure are actually provided. Thus, the following description does not become unnecessarily lengthy, which facilitates the easy comprehension of those skilled in the art. In addition, the accompanying drawings and the following explanations are provided for those skilled in the art to fully understand this application and are not intended to limit the subject matter recorded in the claims.

The “scope” disclosed in this application is limited in the form of a lower limit and an upper limit. The given scope is limited by selecting a lower limit and an upper limit, and the selected lower limit and upper limit the boundary of the special scope. The range defined in this way may include or exclude end values, and may be arbitrarily combined, that is, any lower limit can be combined with any upper limit to form a range. For example, if ranges of 60-120 and 80-110 are listed for a particular parameter, it is to be understood that ranges of 60-110 and 80-120 are also expected. In addition, if the minimum range values 1 and 2 are listed, and if the maximum range values 3, 4, and 5 are listed, the following ranges can all be expected: 1-3, 1-4, 1-5, 2-3, 2-4, and 2-5. In this application, unless otherwise specified, the numerical range “a to b” represents an abbreviated representation of any combination of real numbers between a and b, where a and b are both real numbers. For example, the numerical range “0-5” means that all real numbers between 0-5 are listed herein, and “0-5” is merely an abbreviated representation of the combination of these numbers. In addition, when a parameter is expressed as an integer ≥2, it is equivalent to disclosing that the parameter is, for example, an integer of 2, 3, 4, 5, 6, 7, 8, 9, 10, 11, 12, or the like.

Unless otherwise specified, all the embodiments and optional embodiments of this application can be combined with each other to form new technical solutions, and such technical solutions should be considered to be included in the disclosure of this application.

Unless otherwise specified, all the technical features and optional technical features of this application can be combined with each other to form new technical solutions, and such technical solutions should be considered to be included in the disclosure of this application.

Unless otherwise specified, all the steps in this application can be performed in the order described or in random order, and preferably in the order described. For example, the method includes steps (a) and (b), meaning that the method may include steps (a) and (b) performed sequentially, or may include steps (b) and (a) performed sequentially. For example, reference to “the method may further include step (c)” indicates that step (c) may be added to the method in any order, e.g., the method may include steps (a), (b) and (c), or steps (a), (c) and (b), or steps (c), (a) and (b), or the like.

In this application, the term “a plurality of” or “a plurality of types of” indicates two or more.

Unless otherwise specified, the terms used in this application have well known meanings as commonly understood by a person skilled in the art.

Unless otherwise stated, the values of the parameters mentioned in this application can be measured by various test methods commonly used in the art, for example, can be measured according to the test methods given in the embodiments of this application. Unless otherwise specified, the test temperature of the parameters is 25 °C.

In the embodiments of this application, a battery apparatus may include one or more battery cell assemblies, configured to supply voltage and capacity. The battery cell assembly may include a plurality of pouch-type battery cells. The plurality of pouch-type battery cells are connected in series, in parallel, or in series-parallel through a bus component. For example, the battery cell assembly is usually formed by arranging the plurality of pouch-type battery cells. The battery cell assembly may be a battery module. The battery module is an independent module formed by arranging and securing the plurality of pouch-type battery cells. For example, the battery module may be formed by tying the plurality of battery cells through a strap.

The battery apparatus may be a battery pack. The battery pack includes a box body and one or more battery cell assemblies. The battery cell assembly is accommodated in the box body. The battery cell assembly may be a battery module. The battery cell assembly may be accommodated in the box body by securing the battery module in the box body. The battery cell assembly may alternatively be accommodated in the box body by directly securing the plurality of pouch-type battery cells in the box body.

In the embodiments of this application, the box body may include a first box body and a second box body. The first box body and the second box body are snapped to form a sealed space inside the box body to accommodate the battery cell assembly. The “sealed” means “covered” or “closed”, or may be hermetic, or may be non-hermetic. The first box body may be a top cover or a bottom plate. For example, the box body may include a top cover, a frame, and a bottom plate. The top cover and the bottom plate are connected to the frame to form a sealed space inside the box body to accommodate the battery cell assembly.

In the embodiments of this application, the box body may be used as a part of the chassis structure of a vehicle. For example, a part of the box body may serve as at least a part of the floor of a vehicle, or a part of the box body may serve as at least a part of the cross beam and longitudinal beam of a vehicle.

In the embodiments of this application, the battery cell may be a secondary battery. The secondary battery is a battery cell whose active material can be activated for continuous use through charging after the battery cell is discharged. The battery cell may be a lithium ionic battery. The battery cell may be flat-shaped.

A battery mentioned in embodiments of this application may be a single physical module including one or more battery cells to provide a higher voltage and a higher capacity. For example, the battery provided in this application may include a battery cell, a battery module, a battery pack, or the like.

The battery cell is the smallest unit constituting the battery, and can achieve functions of charging and discharging independently. When a plurality of battery cells are provided, the plurality of battery cells are connected in series, in parallel, or in series-parallel through a bus component. In some embodiments, the battery may be a battery module. When a plurality of battery cells are provided, the plurality of battery cells are arranged and fastened to form one battery module. In some embodiments, the battery may be a battery pack. The battery pack includes a box body and battery cells. The battery cells or the battery module is accommodated in the box body. In some embodiments, the box body may be used as a part of the chassis structure of a vehicle. For example, a part of the box body may serve as at least a part of the underbody of a vehicle, or a part of the box body may serve as at least a part of the cross beam and longitudinal beam of a vehicle.

In some embodiments, the battery may be an energy storage apparatus. The energy storage apparatus includes an energy storage container, an energy storage cabinet, and the like.

In some embodiments, the battery cell may be assembled into a battery module, the battery module may include a plurality of battery cells, and a specific quantity of battery cells may be adjusted according to the application and capacity of the battery module. In some embodiments, the battery modules may further form a battery pack, and a quantity of battery modules included in the battery pack may be adjusted based on the application and capacity of the battery pack.

The battery cell includes an electrode assembly and an electrolyte.

The electrode assembly usually includes a positive electrode plate and a negative electrode plate. The negative electrode plate is an electrode at which reactions occur to absorb or lithiate lithium ions during charging and release lithium or delithiate lithium during discharging. The positive electrode plate is an electrode at which reactions occur to release lithium ions or delithiate lithium during charging and absorb or lithiate lithium during discharging.

Lithium-containing transition metal phosphate used as a positive electrode active material has significant advantages in the aspect of cycle stability, but has an intrinsic gram capacity significantly lower than that of a ternary material. The applicant finds that the use of a thick-coating process in an electrode preparation link becomes an effective technical measure to compensate for the disadvantage of low capacity of lithium-containing phosphate, and a pouch-type casing is used, having a lighter weight, thereby further increasing the theoretical gravimetric energy density of the battery cell. However, this process improvement also poses new technical challenges: In one aspect, a thick electrode plate exhibits higher expansion stress during long-term cycling, and in another aspect, heat generated during the operation of the thick electrode plate is difficult to effectively dissipate, and localized high temperature leads to the decomposition of the electrolyte to generate gas, causing an increase in the internal pressure of the battery. Because pouch-type encapsulation has limited mechanical strength, the internal expansion and the increase in pressure may cause bulging of the electrode assembly or even lead to a crack failure of encapsulation.

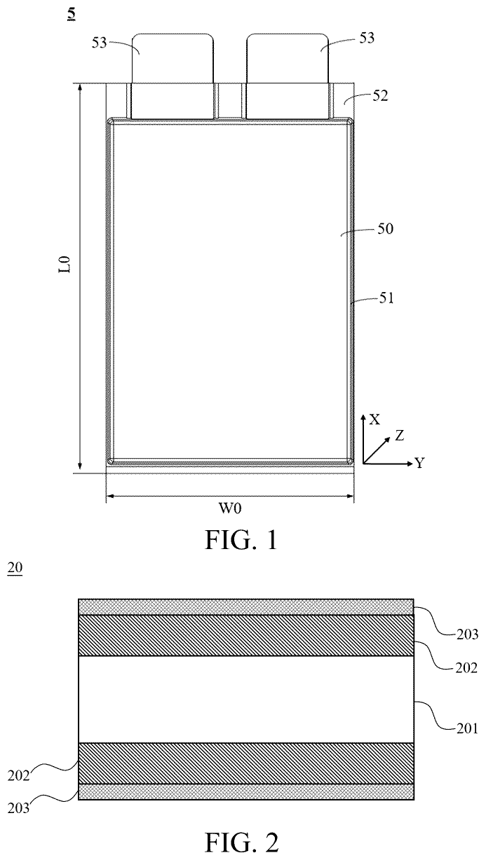

A first aspect of this application provides a battery cell, as shown in FIG. 1, including a stacked electrode assembly and a housing 50, where the stacked electrode assembly is accommodated in the housing 50, and the housing 50 is made of a pouch-type material; the housing 50 includes a first sealing zone 51, and the first sealing zone 51 is disposed at at least one end of the stacked electrode assembly extending along a width direction (a Y direction); the first sealing zone includes a double-folded edge structure extending along a length direction (an X direction), a sealing adhesive is disposed on the double-folded edge structure, and the sealing adhesive is continuously disposed in the length direction (the X direction) and secures the double-folded edge structure; the stacked electrode assembly includes a positive electrode plate, a negative electrode plate, and an electrolyte, the positive electrode plate includes a positive electrode current collector and a positive electrode film layer disposed on at least one side of the positive electrode current collector, the positive electrode film layer includes lithium-containing transition metal phosphate particles, and at least a portion of a surface of the lithium-containing transition metal phosphate particles is provided with a carbon material; based on a total area of particles in a cross-section of the positive electrode film layer in a thickness direction of the positive electrode plate, an area percentage of particles whose particle size R1 meets R1≥1000 nm ranges from 12% to 50%; a single-side thickness of the positive electrode film layer is denoted as H, and H ranges from 70 μm to 120 μm; when the battery cell is in a fully-discharged state, a compaction density of the positive electrode plate ranges from 2.3 g/cm³ to 2.6 g/cm³; and the electrolyte includes a solvent, and the solvent includes dimethyl carbonate (DMC); and based on a total mass of the electrolyte, a mass percentage of dimethyl carbonate ranges from 18% to 32%.

Lithium-containing transition metal phosphates all have relatively low gram capacities. Research shows that when the single-side thickness H of the positive electrode film layer is less than 70 μm, the battery capacity struggles to meet market demand. In the embodiments of this application, the single-side thickness H of the positive electrode film layer is controlled within the range of 70 μm to 120 μm, which is conducive to increasing the space utilization of active materials, and a casing of a pouch-type material is further used, thereby reducing the weight of the battery cell, and improving the gravimetric energy density of the battery. However, the thick positive electrode film layer undergoes significant volume changes due to lithium intercalation and lithium deintercalation during charge-discharge cycles, leading to the accumulation of mechanical stress, and further causing the expansion and contraction of electrode materials. The electrode plates exhibit springback and an increase in thickness, causing an increase in mechanical stress in an encapsulation structure. In addition, the thick film layer means more difficult conduction of internal heat and proneness to local overheating, which aggravates side reactions and gas generation of the electrolyte, thereby further increasing the internal pressure of the battery cell. Compared with a wound structure, the structure of the stacked electrode assembly reduces void spaces, thereby improving the volumetric energy density. However, the stacked electrode assembly lacks the restraining effect provided by the wound structure and offers limited suppression of springback in the thick-coating film layer, resulting in degraded reliability of the battery cell. Compared with hard shell materials, the pouch-type material exhibits lower mechanical strength and reduced capability to withstand internal pressure. In addition, the pouch-type material exhibits lower thermal conductivity, which may lead to easier heat accumulation inside the battery cell, further exacerbating gas generation issues. During long-term use, excessive internal pressure may rupture the sealing zone.

In the embodiments of this application, the first sealing zone includes the double-folded edge structure extending along a long-side direction, thereby further improving the sealing strength of the first sealing zone. The double-folded edge folds and encapsulates the pouch-type material of the housing twice, thereby forming a multi-layered sealing barrier. Even if the first-layer folded edge structure develops a defect due to springback stress from the high thickness of the positive electrode film layer in the electrode assembly and the gas generation of the electrolyte, the second-layer folded edge structure can still remain sealed. In addition, because the pouch-type material is thermally fused and bonded during battery processing, the double-folded edge can make the thermally-sealed region more uniform, thereby mitigating inadequate sealing in localized regions. The sealing junction is a vulnerable link in the mechanical strength of the pouch-type electrode assembly, thereby further enhancing the reliability of encapsulation. The inventor arranges the sealing adhesive on the double-folded edge structure. The sealing adhesive is continuously disposed in the long-side direction and secures the double-folded edge structure, and may cover microcracks or defects of the thermally-sealed region in the sealing zone of the pouch-type material. In addition, the double-folded edge structure retains particular elastic memory after thermal sealing, and may spring back after long-term use. The sealing adhesive may secure the double-folded edge structure, thereby maintaining the stability of the structure. In the embodiments of this application, when the battery cell is in the fully-discharged state, the compaction density of the positive electrode plate may be further controlled to range from 2.3 g/cm³ to 2.6 g/cm³, so that in one aspect, the battery cell has high capacity, and in another aspect, a particular cushioning space is provided between particle accumulation structures, thereby reducing stress applied on the encapsulation structure by the springback of the electrode plate. To further reduce the stress inside the battery cell, the inventor regulates the area percentage of the particles whose particle size R1 meets R1≥1000 nm in the positive electrode film layer and the mass percentage of dimethyl carbonate in the electrolyte. The inventor finds that with the same expansion rate, compared with large particles, it is easier for the expansion of small particles to be absorbed by tiny pore structures between particles. Large particles exhibit large absolute expansion changes, and are more difficult to be dissipated. When the area percentage of the particles whose particle size R1 meets R1≥1000 nm is greater than 50%, stress concentration tends to occur, and distinct springback occurs, resulting in an increase in the internal pressure of the battery cell. When the area percentage of the particles whose particle size R1 meets R1≥1000 nm is less than 12%, the optimization of the particle size distribution and compaction density of the positive electrode film layer are restricted, failing to effectively improve the battery capacity. Therefore, the area percentage of the particles whose particle size R1 meets R1≥1000 nm is controlled to range from 12% to 50%, which is conducive to further improving the reliability of the battery cell while maintaining energy density. Dimethyl carbonate has multiple advantages such as low viscosity, excellent low-temperature performance, and low costs. When the mass percentage of dimethyl carbonate in the electrolyte is lower than 18%, it is difficult to constitute a low-viscosity system, and it is difficult to increase the overall ion conductivity of the electrolyte, which causes an increase in the ohmic impedance inside the battery, leading to increased Joule heat. Chain carbonate exhibits weak oxidation resistance, and the symmetric structure of dimethyl carbonate is more prone to decomposition in a high-voltage or high-temperature environment. When the mass percentage of dimethyl carbonate is higher than 32%, gas generation is severe in long cycling, resulting in an increase in a probability of an encapsulation failure. The mass percentage of dimethyl carbonate in the electrolyte is controlled to range from 18% to 32%, so that a balance can be achieved between the low viscosity and the gas generation risk of the electrolyte. The foregoing technical measures collaborate to further achieve a balance between the energy density and the reliability of the battery.

In this application, the term “double-folded edge” is a reinforced structure formed by folding a sealing zone. The sealing zone is folded for the first time, and is folded again along the folding direction of first time or the opposite direction. Compared with a single-folded edge structure, the sealing zone has higher strength, and can withstand higher internal pressure without a rupture failure. A further “multi-folded edge” causes an exponential increase in process difficulty and costs, and makes no significant improvement to the strength of the sealing zone.

Lithium-containing transition metal phosphates are phosphate materials that contains lithium and a transition metal, and may be detected in any manner known in the field. For example, lithium-containing transition metal phosphates may be detected by combining an X-ray diffractometer (XRD) and an energy dispersive spectrometer.

In this application, the term “particle” refers to an entity within the positive electrode film layer that exhibits a discernible and complete boundary in the field of view at a specified magnification (e.g., 10,000×). Defects or scratches may exist within the particle, but no complete boundary sufficient to segment the particle is identifiable within the particle.

A particle identification method is specifically as follows: cutting the positive electrode film layer along a thickness direction of the electrode plate using an argon ion beam (e.g., Equipment Model: Leica EM TIC 3X CP, Operating Voltage: 6 kV, and Operating Duration: 6 h), after a cross-section is exposed, observing the cross-section of the positive electrode film layer in the thickness direction of the electrode plate using a scanning electron microscope (e.g., Equipment Model: Hitachi SU8230, Operating Voltage: 3 kV, Beam Current: high, Detector Model: U(LA100), and Operating Distance: <5 mm). Images are acquired using a field emission scanning electron microscope (FESEM) in secondary electron mode at a non-edge position (after an edge of the electrode plate is observed under the scanning electron microscope, the field of view is adjusted to the central portion of the sample) of the cross-section of the positive electrode film layer. Electron micrographs are captured at a magnification of 10,000×. Particles in the electron micrographs are analyzed using ImageJ software (version 1.46r, win64). A use method of the ImageJ software is specifically as follows: loading a scanning electron micrograph to be analyzed; identifying particles using the Cellpose plugin, followed by manual correction; and reading and collecting statistics of data using ImageJ. A specific method for particle identification using the Cellpose plugin is as follows: setting the segmentation diameter parameter (diameter in the Segmentation module) to 15 pixels, and clicking “runcyto3” to perform particle identification; and manually annotating particles in the image that are not identified by the software, incompletely identified by the software, or inaccurately identified. The particles in the image that are not identified by the software, incompletely identified by the software, or inaccurately identified primarily include the following types: 1. particles are oversized or particles have surface scratches, and as a result fail to be identified or fail to be completely identified; 2. scratches are generated on the surface of particles during argon ion beam cutting, and may be misinterpreted as particle boundaries, leading to identification errors; 3. particles are excessively undersized and fail to successfully identified; and 4. particles are located at a field-of-view edge of an electron microscope, with the interior penetrated by the edge, preventing their complete morphology from being displayed, and as a result partial particles are identified as complete particles, leading to identification errors. The particles that are not identified or inaccurately identified are manually calibrated, a specific procedure being as follows: deleting particles that are located at the edges of the scanning electron microscope and fail to be completely displayed; determining whether fissures or scratches exist in other particles that are not identified or inaccurately identified, if no fissure or scratch exists inside a particle, determining the particle as one particle, and manually annotating the particle based on a manually observed contour of the particle; in response to a fissure or scratch existing inside a particle, determining whether the fissure or scratch penetrates the particle, and if the fissure or scratch does not penetrate the particle, determining the particle as one particle, and manually annotating the particle; in response to the fissure or scratch penetrating a particle, determining whether the fissure or scratch has a linear shape or an irregular shape; in response to the fissure or scratch having an irregular shape, determining that the fissure or scratch is a boundary between particles, and identifying the particles along the boundary; in response to the fissure or scratch having a linear shape, performing contrast comparison; in response to low contrast and the absence of fissure texture, determining the fissure or scratch as a surface scratch, and annotating the particle as one particle; and in response to high contrast and the presence of fissure texture, determining that the fissure or scratch is a boundary between particles, and identifying the particle as two particles. Following manual annotation, information unrelated to particles during automated image processing is eliminated, thereby completing the determination and annotation of particles in the image.

It may be understood that particles in the cross-section of the positive electrode film layer in the thickness direction of the electrode plate, especially particles whose particle size is greater than 50 nm, mainly come from a positive electrode active material. Therefore, in the embodiments of this application, the distribution of lithium-containing transition metal phosphate particles in the positive electrode film layer can be accurately and objectively reflected by observing and collecting statistics of the areas of the particles in the cross-section of the positive electrode plate in the thickness direction of the electrode plate.

In existing technologies, the particle size distribution of the positive electrode active material is typically characterized using a laser particle size analyzer via the Malvern laser diffraction method. However, the applicant's research demonstrates that due to the tendency of lithium-containing transition metal phosphate particles to agglomerate, the Malvern laser diffraction method based on laser scattering principles predominantly measures the particle size of particle agglomerates rather than the true particle size of particles in the positive electrode active material. Furthermore, this method fails to accurately reflect the dispersion state of the positive electrode active material within the film layer, as the dispersion degree of the positive electrode active material within the film layer improves during slurry preparation and film formation/rolling. Test results obtained using the Malvern laser diffraction method are influenced by the particle size, specific surface area, and agglomeration degree of the positive electrode active material. Compared to the actual dispersion state within the electrode plate, this method underestimates the number of large particles and overestimates that of small particles. Consequently, the particle sizes measured using the Malvern laser diffraction method cannot be equated or extrapolated to those statistically derived from the embodiments of this application.

In the cross-section of the positive electrode film layer in the thickness direction of the electrode plate, a test method for the area percentage of the particles whose particle size R1 meets R1≥1000 nm is specifically as follows: identifying the particles in the positive electrode film layer using the foregoing method in this application, importing an image with particle determination and identification completed into the ImageJ software for analysis, completing the scale bar setup based on the scanning electron micrograph, and statistically analyzing the particle sizes, areas, sphericity, and roughness of the particles in the cross-section of the positive electrode film layer in the thickness direction of the electrode plate using “Feret diameter”, “Area”, “Round”, and “Solidity” analysis functions. According to the software manual (ImageJ User Guide IJ 1.46r), the analyzed “Feret” parameter represents the maximum distance between any two parallel lines in the two-dimensional projection of a particle, thereby characterizing the particle size of the particle. The obtained “Area” parameter represents the pixel area of the particle. To meet a statistically significant sample count, at least 10 scanning electron micrographs are acquired from each film layer, and the statistics of particle sizes of at least 1000 particles is collected. The particles whose particle size is less than 50 nm are prone to a large error in statistics and are very difficult to accurately identify, and the particle size of the conductive agent is usually less than 50 nm and causes a large error to a statistical result. Therefore, in the process of collecting statistics of particle sizes in this application, the particles whose particle size is less than 50 nm are excluded, and statistical data of particles corresponding to AR, Round or Solidity displayed as “NaN” is deleted. A sum of “Area” parameters of the particles whose particle size R1 meets R1≥1000 nm and a sum of “Area” parameters of all the particles are calculated and are respectively used as a sum of areas of the particles whose particle size R1 meets R1≥1000 nm and a total area of statistically analyzed particles. The sum of areas of the particles whose particle size R1 meets R1≥1000 nm is divided by the total area of the statistically analyzed particles to obtain the quotient as the area percentage of the particles whose particle size R1 meets R1≥1000 nm in the cross-section of the positive electrode film layer in the thickness direction of the electrode plate.

In some embodiments, based on the total area of the particles in the cross-section of the positive electrode film layer in the thickness direction of the electrode plate, the area percentage of the particles whose particle size R1 meets R1≥1000 nm is optionally 12%, 12.11%, 13%, 14%, 15%, 6, 17%, 18%, 19%, 20%, 21%, 22%, 23%, 24%, 25%, 26%, 27%, 28%, 29%, 30%, 31%, 32%, 33%, 34%, 34.89%, 34.97%, 35%, 36%, 36.71%, 36.75%, 36.83%, 36.92%, 36.95%, 37%, 38%, 38.09%, 39%, 40%, 41%, 42%, 43%, 44%, 45%, 46%, 47%, 48%, 49%, 49.99%, 50%, or a value range between any two of the foregoing.

In some embodiments, the single-side thickness of the positive electrode film layer is denoted as H, and H is optionally 70 μm, 70.45 μm, 75 μm, 80 μm, 85 m, 90 μm, 91.88 μm, 95 μm, 96.75 μm, 100 μm, 105 μm, 106.02 μm, 106.09 μm, 106.10 am, 106.34 μm, 106.66 μm, 106.79 μm, 110 μm, 115 μm, 119.49 μm, 120 μm, or a value range between any two of the foregoing.

In some embodiments, when the battery cell is in the fully-discharged state, the compaction density of the positive electrode plate is optionally 2.3 g/cm³, 2.31 g/cm³, 2.32 g/cm³, 2.33 g/cm³, 2.34 g/cm³, 2.35 g/cm³, 2.36 g/cm³, 2.37 g/cm³, 2.38 g/cm³, 2.39 g/cm³, 2.4 g/cm³, 2.41 g/cm³, 2.42 g/cm³, 2.43 g/cm³, 2.44 g/cm³, 2.45 g/cm³, 2.46 g/cm³, 2.47 g/cm³, 2.48 g/cm³, 2.49 g/cm³, 2.5 g/cm³, 2.51 g/cm³, 2.52 g/cm³, 2.53 g/cm³, 2.54 g/cm³, 2.55 g/cm³, 2.56 g/cm³, 2.57 g/cm³, 2.58 g/cm³, 2.59 g/cm³, 2.6 g/cm³, or a value range between any two of the foregoing.

In this application, the fully-discharged state is a state obtained by placing a battery in a 25 °C oven environment, resting the battery for 2 h, waiting for the temperature of the battery to maintain 25 °C, discharging the battery at a ⅓C constant current to 2.5 V, and discharging the battery at a 0.1 C constant current to 2.0 V.

In this application, the compaction density of the positive electrode plate can be tested by using a method known in the art. For example, the battery is placed in a 25 °C oven environment and is rested for 2 h. When the temperature of the battery maintains 25 °C, the battery is discharged to 2.5 V at a ⅓C constant current and is discharged to 2.0 V at a 0.1 C constant current. The battery is disassembled to obtain the positive electrode plate. The residual electrolyte is processed using a dimethyl carbonate solvent. The electrode plate is dried, and is cut into a disc with an area of S. It is obtained that the mass of the disc is W₁, and the thickness T₁ of the positive electrode plate is measured using a ten-thousandth micrometer. The positive electrode film layer of the foregoing weighed electrode plate is then wiped off. The mass of the current collector is weighed and denoted as W₂, and the thickness T₂ of the current collector is measured using the ten-thousandth micrometer. The compaction density of the positive electrode plate PD=(W₁−W₂)/[(T₁−T₂)×S].

In some embodiments, based on the total mass of the electrolyte, the mass percentage of dimethyl carbonate is optionally 18%, 19%, 20%, 21%, 22%, 23%, 24%, 25%, 26%, 27%, 28%, 29%, 30%, 31%, 32%, or a value range between any two of the foregoing.

In some embodiments, the sealing adhesive includes a blue strip adhesive. The blue strip adhesive has high viscosity, so that the sealing zone of the housing is bonded more securely, to further enhance the strength of the first sealing zone, thereby improving the reliability of the battery cell.

Dimethyl carbonate exhibits excellent solubility for lithium hexafluorophosphate, and can provide a sufficient lithium ion concentration when being used as an electrolyte component, thereby meeting a necessary ion conduction condition. In addition, dimethyl carbonate has low viscosity, which is conducive to improving the ion conductivity of the electrolyte, thereby improving the rate performance and the low-temperature performance of the battery cell.

In any embodiment, the single-side thickness of the positive electrode film layer is denoted as H, and H ranges from 90 μm to 120 μm, and optionally ranges from 100 μm to 120 μm.

The single-side thickness of the positive electrode film layer is within the foregoing range, which is conducive to further improving energy density. The applicant finds that when the single-side thickness of the positive electrode film layer is greater than 100 μm, the positive electrode plate exhibits a more severe springback phenomenon. In the embodiments of this application, through the double-folded edge structure of the first sealing zone, the structural strength of the housing is increased, thereby reducing a probability that sealing is ruptured due to internal stress from the springback of the film layer, so that the reliability of the battery is enhanced while high energy density is maintained.

In some embodiments, as shown in FIG. 1, the housing 50 includes at least one second sealing zone 52, the second sealing zone 52 is disposed at at least one end of the stacked electrode assembly in the length direction of the housing, and the second sealing zone 52 is disposed on a tab side of the stacked electrode assembly.

It may be understood that the positive electrode tab and the negative electrode tab may be disposed on the same side of the stacked electrode assembly, as shown in FIG. 4, or may be disposed on different sides of the stacked electrode assembly.

In some embodiments, the battery cell 5 further includes a terminal 53. The terminal 53 is connected to a tab of the battery cell. For example, the terminal 53 may be soldered to the tab. The terminal 53 is a conductive member. The terminal 53 is at least partially located outside the housing 50. The terminal 53 is used as an electrode leading-out end of the battery cell 5. The terminal 53 is configured to facilitate the electrical connection between the battery cell 5 and another battery cell 5 or another component. For example, the terminal 53 may have a sheet shape.

Correspondingly, the terminal 53 also includes a positive electrode terminal and a negative electrode terminal, the positive electrode terminal is connected to the positive electrode tab, and the negative electrode terminal is connected to the negative electrode tab.

In some embodiments, the second sealing zone is disposed on the tab side. The tab and a terminal need to be connected to each other. The connection strength between the terminal and the housing material is relatively weak, making it easy for gas to vent through the second sealing zone, which is conducive to achieving directional pressure relief for the battery, thereby reducing the impact on an adjacent electrode assembly when sealing fails, and improving the overall safety and reliability of a battery apparatus.

In some embodiments, an outer periphery of the stacked electrode assembly is provided with a plurality of adhesive rings surrounding along the width direction, and the adhesive rings surrounding along the width direction are disposed at intervals in the length direction.

The adhesive rings surrounding along the width direction of the electrode assembly are arranged at intervals in the length direction, which is conducive to increasing the restraining force on the electrode assembly, and is especially applicable to a battery cell having a thick-coating film layer, so that the springback rate of the positive electrode film layer and the springback pressure on the sealing zone can be effectively reduced, thereby further reducing a probability of a failure in the sealing zone, and improving the reliability of the battery cell.

In some embodiments, based on the total area of particles in the cross-section of the positive electrode film layer in the thickness direction of the positive electrode plate, the area percentage of particles whose particle size R1 meets R1≥1000 nm ranges from 12% to 37%.

When the area percentage of the particles whose particle size R1 meets R1≥1000 nm is within the foregoing range, an expansion force applied on the pouch-type material and the sealing zone by the springback of large particles is further reduced, thereby improving the reliability of the battery cell.

In some embodiments, in the cross-section of the positive electrode film layer in the thickness direction of the electrode plate, in an area-weighted cumulative distribution curve of sphericity of particles whose particle size R1 meets R1≥1000 nm, a median L_{R1A50} of sphericity ranges from 0.6 to 0.8, optionally ranges from 0.65 to 0.75, and further optionally, ranges from 0.67 to 0.75.

In the cross-section of the positive electrode film layer in the thickness direction of the electrode plate, a test method for the sphericity of the particles whose particle size R1 meets R1≥1000 nm is specifically as follows: identifying the particles in the positive electrode film layer using the foregoing method in this application, importing an image with particle determination and identification completed into the ImageJ software for analysis, completing the scale bar setup based on the scanning electron micrograph, and statistically analyzing the particle sizes and sphericity of the particles in the cross-section of the positive electrode film layer in the thickness direction of the electrode plate using “Feret diameter” and “Round” analysis functions. According to the software manual (ImageJ User Guide IJ 1.46r), the analyzed “Feret” parameter represents the maximum distance between any two parallel lines in the two-dimensional projection of a particle, thereby characterizing the particle size of the particle. According to the software manual (ImageJ User Guide IJ 1.46r), the analyzed “Round” parameter represents a ratio of a pixel area of a particle to an area of a circle with a fitted major axis as the diameter, which may be configured to characterize the sphericity of the particle. When the particle is closer to a spherical shape, the ratio of the pixel area to the area of the circle with the fitted major axis as the diameter is closer to 1. Therefore, the “Round” parameter of the particle obtained through analysis is configured to characterize the sphericity of the particle. To meet a statistically significant sample count, at least 10 scanning electron micrographs are acquired from each film layer, and the statistics of particle sizes of at least 1000 particles is collected. The obtained sphericity of the particles whose particle size R1 meets R1≥1000 nm is sorted in ascending order. The cumulative distribution curve of the sphericity of the particles in the positive electrode film layer is obtained with the sphericity with a horizontal axis and the cumulative area percentage as a vertical axis. L_{R1A50} is a corresponding L value of sphericity when the cumulative area percentage on the vertical axis is 50% in the L-value cumulative distribution curve of sphericity of the particles whose particle size R1 meets R1≥1000 nm.

In some embodiments, in the cross-section of the positive electrode film layer in the thickness direction of the electrode plate, in the area-weighted cumulative distribution curve of sphericity of particles whose particle size R1 meets R1≥1000 nm, the median L_{R1A50} of sphericity is optionally 0.6, 0.61, 0.62, 0.63, 0.64, 0.65, 0.66, 0.67, 0.673, 0.68, 0.687, 0.69, 0.7, 0.71, 0.72, 0.73, 0.74, 0.745, 0.75, 0.76, 0.77, 0.78, 0.79, 0.8, or a value range between any two of the foregoing.

A person skilled in the art may achieve the regulation of the sphericity of particles through any known process. For example, the adjustment of the sphericity of particles can be achieved through processes such as lapping, polishing, chemical etching, mechanical stirring, extrusion, coating, granulation, and surfactant addition and the adjustment of parameters in the processes.

In the area-weighted cumulative distribution curve of sphericity of the particles whose particle size R1 meets R1≥1000 nm, L_{R1A50} is within the foregoing range. The particles exhibit a more ideal spherical morphology and are easily rollable, so that volume changes caused by the springback of the thick positive electrode film layer or charge-discharge expansion can be accommodated through the rearrangement of packing configurations within a particular space range, thereby reducing the burden on the first sealing zone, and improving the reliability of the battery cell.

In some embodiments, in the cross-section of the positive electrode film layer in the thickness direction of the electrode plate, a distribution uniformity of particles whose particle size R1 meets R1≥1000 nm is less than or equal to 5%, optionally ranges from 0.2% to 2%, and further optionally, ranges from 0.2% to 0.9%.

The distribution uniformity of the particles whose particle size R1 meets R1≥1000 nm in the cross-section of the positive electrode film layer in the thickness direction of the electrode plate can be tested by using a method known in the art. For example, the cross-section of the positive electrode film layer in the thickness direction of the electrode plate is divided into three layers with equal thicknesses in the thickness direction of the electrode plate, which are respectively a lower layer close to the positive electrode current collector, an upper layer far away from the positive electrode current collector, and a middle layer placed between the upper layer and the lower layer. 10 nonoverlapping fields of view are selected from each of the upper layer, the middle layer, and the lower layer, and scanning electron micrographs are taken at 10,000×. The 30 taken scanning electron micrographs are respectively imported into the ImageJ software for analysis. Test is performed according to the foregoing “test method for the area percentage of the particles whose particle size R1 meets R1≥1000 nm in the cross-section of the positive electrode film layer in the thickness direction of the electrode plate” to obtain the area percentages of particles whose diameter R1 meets R1≥1000 nm in the 30 micrographs, and a total of 30 values are obtained. The obtained range of the 30 values is the distribution uniformity of the particles whose particle size R1 meets R1≥1000 nm in the cross-section of the positive electrode film layer in the thickness direction of the electrode plate, and the range is a difference value between the largest value and the smallest value in the 30 values. When the distribution uniformity of the particles whose particle size R1 meets R1≥1000 nm in the cross-section of the positive electrode film layer in the thickness direction of the electrode plate is smaller, it represents that large particles whose particle size R1 meets R1≥1000 nm in the positive electrode film layer are distributed more uniformly, which is conducive to mitigating the phenomenon of stress concentration at large particles in the positive electrode film layer, to reduce the springback rate of the positive electrode film layer and the impact on the housing and the sealing zone, thereby improving the reliability of the battery cell.

In some embodiments, the distribution uniformity of the particles whose particle size R1 meets R1≥1000 nm in the cross-section of the positive electrode film layer in the thickness direction of the electrode plate is optionally 0.01%, 0.1%, 0.2%, 0.24%, 0.3%, 0.4%, 0.45%, 0.5%, 0.6%, 0.7%, 0.8%, 0.9%, 0.99%, 1%, 1.1%, 1.2%, 1.3%, 1.4%, 1.47%, 1.5%, 1.6%, 1.7%, 1.8%, 1.81%, 1.82%, 1.85%, 1.9%, 1.94%, 1.95%, 1.98%, 1.99%, 2%, 2.1%, 2.2%, 2.3%, 2.4%, 2.45%, 2.5%, 2.6%, 2.7%, 2.8%, 2.81%, 2.82%, 2.83%, 2.85%, 2.9%, 2.94%, 2.98%, 3%, 3.1%, 3.2%, 3.3%, 3.4%, 3.5%, 3.6%, 3.7%, 3.8%, 3.9%, 4%, 4.1%, 4.2%, 4.3%, 4.4%, 4.5%, 4.6%, 4.7%, 4.8%, 4.9%, 4.91%, 5%, or a value range between any two of the foregoing.

In some embodiments, the distribution uniformity of the particles whose particle size R1 meets R1≥1000 nm in the cross-section of the positive electrode film layer in the thickness direction of the electrode plate ranges from 0.2% to 2%.

In some embodiments, the distribution uniformity of the particles whose particle size R1 meets R1≥1000 nm in the cross-section of the positive electrode film layer in the thickness direction of the electrode plate ranges from 0.2% to 0.9%.

The distribution uniformity of the particles whose particle size R1 meets R1≥1000 nm in the cross-section of the positive electrode film layer in the thickness direction of the electrode plate is within the foregoing range, so that the stress concentration degrees in localized regions in the film layer can be effectively reduced, and the springback stress in the cycling process of the thick-coating film layer can be uniformly dispersed in the entire region of the film layer to reduce the springback rate of the positive electrode film layer, thereby reducing a probability of a failure of the encapsulation structure while improving the energy density of the battery, and improving the reliability of the battery.

In some embodiments, the solvent in the electrolyte further includes one or two of ethyl methyl carbonate (EMC) and ethylene carbonate (EC).

The types and masses of the solvent in the electrolyte and the electrolyte salt may be obtained by detecting the electrolyte using a method well known to a person skilled in the art. For example, the composition of the electrolyte can be determined through liquid chromatography, ultraviolet spectrophotometry, ultraviolet-visible spectrophotometry, or the like. For example, the battery cell is disassembled to obtain the free electrolyte. The free electrolyte from the battery cell is diluted with acetonitrile by 3 to 10 times to obtain a test-ready diluted electrolyte solution. A GC-MS 3100 organic component gas chromatograph is used, the diluted electrolyte solution is placed into the instrument for full-scan qualitative analysis with an inlet temperature of 250 °C and a scan range of m/z 35 to 270. Upon completion of the test, a total ion chromatogram for organic compounds is obtained. Organic species corresponding to the organic compounds are identified by comparing peak positions in the chromatogram, and content percentages corresponding to the organic compounds are calculated based on peak areas. For example, an ion chromatograph (IC) can be used to test inorganic contents in the electrolyte. A quantitative amount of the electrolyte (diluted to a concentration in the middle of the standard curve) is weighed and is diluted to 100 mL with ultrapure water in a volumetric flask, and automated ion chromatograph analysis is performed via an autosampler. The resulting ion chromatogram of inorganic contents is used to identify inorganic species corresponding to the inorganic contents by comparing peak positions in the chromatogram.

In some embodiments, based on the total mass of the electrolyte, a mass percentage of ethyl methyl carbonate (EMC) ranges from 39% to 49%.

In some embodiments, based on the total mass of the electrolyte, the mass percentage of ethyl methyl carbonate (EMC) is optionally 39%, 40%, 40.3%, 41%, 42%, 43%, 43.3%, 44%, 45%, 46%, 47%, 47.3%, 48%, 49%, or a value range between any two of the foregoing.

At 25 °C, ethyl methyl carbonate (EMC) has a viscosity of 0.65 mPa s, which is higher than that of DMC but less than that of EC, and still maintains excellent flowability at a low temperature, so that EMC and DMC jointly achieve the function of reducing the overall viscosity of the electrolyte, thereby improving the migration rate of lithium ions in the electrolyte, and reducing Joule heat. In addition, compared with DMC, EMC has higher oxidative stability and thermal stability, thereby further reducing the decomposition and gas generation of the electrolyte, and improving the reliability of the battery cell.

In some embodiments, based on the total mass of the electrolyte, a mass percentage of ethylene carbonate (EC) ranges from 13% to 22%.

In some embodiments, based on the total mass of the electrolyte, based on the total mass of the electrolyte, the mass percentage of ethylene carbonate (EC) is optionally 13%, 14%, 15%, 16%, 17%, 18%, 19%, 20%, 21%, 22%, or a value range between any two of the foregoing.

Ethylene carbonate (EC) has an exceptionally high dielectric constant, which enables effective dissolution of lithium salts, thereby improving the ion conductivity of the electrolyte, and ensuring the smooth migration of lithium ions. EC within the mass percentage range can decompose on the surface of a negative electrode active material and form a stable SEI film, thereby reducing side reactions, and improving the cycle life.

In some embodiments, based on the total mass of the electrolyte, a total mass percentage of ethyl methyl carbonate (EMC) and ethylene carbonate (EC) ranges from 52% to 71%.

In some embodiments, based on the total mass of the electrolyte, the total mass percentage of ethyl methyl carbonate (EMC) and ethylene carbonate (EC) is optionally 52%, 53%, 54%, 54.66%, 55%, 56%, 57%, 58%, 59%, 60%, 60.66%, 61%, 62%, 63%, 64%, 65%, 66%, 67%, 68%, 68.66%, 69%, 70%, 71%, or a value range between any two of the foregoing.

The total mass content of EC and EMC is within the foregoing range, and the complementary combination of EC and EMC overcomes the problems that the viscosity of EC is high and the SEI film formed by EMC has poor thermal stability and mechanical strength, thereby achieving the optimization of the performance of the electrolyte, and further reducing the pressure of Joule heat and the decomposition and gas generation of the SEI film on the sealing zone in the direction of optimizing the ion conductivity and the SEI film.

In some embodiments, the electrolyte includes an electrolyte salt, the electrolyte salt includes lithium hexafluorophosphate (LiPF₆), and a concentration of lithium hexafluorophosphate in the electrolyte ranges from 0.9 mol/L to 1.2 mol/L.

In some embodiments, the concentration of lithium hexafluorophosphate in the electrolyte is 0.9 mol/L, 0.95 mol/L, 1.0 mol/L, 1.05 mol/L, 1.1 mol/L, 1.15 mol/L, 1.2 mol/L, or a value range between any two of the foregoing.

Lithium hexafluorophosphate (LiPF₆) can highly dissolve in carbonate-based solvents to form a high-concentration electrolyte, thereby ensuring the high ion conductivity of lithium ions in the electrolyte. In addition, a low-potential negative electrode can induce the stable formation of the SEI film, and reduce lithium deposition, thereby improving the cycle life. The concentration of lithium hexafluorophosphate is excessively high, and the viscosity of the electrolyte is clearly increased, leading to limited diffusion of lithium ions, and the ion conductivity is decreased. In addition, decomposition results of lithium hexafluorophosphate includes PF₅, which further reacts with a slight amount of water in the electrolyte to generate HF, and further corrode the electrode and the SEI film, thereby aggravating the decomposition and gas generation of the solvent. The concentration of lithium hexafluorophosphate is within the foregoing range, so that an optimal balance can be achieved among the aspects such as the ion conductivity and the stability of the electrolyte.

In some embodiments, based on the total mass of the electrolyte, a mass percentage of dimethyl carbonate ranges from 18% to 26%.

The mass percentage of dimethyl carbonate is within the foregoing range, and EC and EMC with higher percentages are introduced, to further reduce the capability and probability of gas generation of the electrolyte, thereby improving the long-term reliability of the battery cell.

In some embodiments, the electrolyte further includes vinylene carbonate (VC), and based on the total mass of the electrolyte, a mass percentage of vinylene carbonate ranges from 0.5% to 1.5%.

Vinylene carbonate undergoes reduction reactions on the negative electrode surface preferentially over other solvent components to generate a dense SEI film that is rich in organic lithium compounds. The SEI film exhibits high lithium ion conductivity, which is conducive to improving the kinetic performance of the battery cell. The SEI film also has high mechanical strength and chemical stability and can inhibit the continuous decomposition of the electrolyte, thereby reducing the consumption of active lithium and gas generation from side reactions.

In some embodiments, in a cumulative distribution curve of a graphitization degree C value obtained from the positive electrode film layer in an area mapping mode of a laser microscopic confocal Raman spectrometer, a median C₅₀ of the graphitization degree ranges from 0.95 to 1.20, the graphitization degree C value is I_{G}/I_{D}, I_{G} represents the intensity of the G band at 1580±100 cm⁻¹ in Raman spectra, and I_{D} represents the intensity of the D band at 1350±100 cm⁻¹ in Raman spectra.

In this application, the graphitization degree C value of the positive electrode film layer may be obtained in the area mapping mode of the laser microscopic confocal Raman spectrometer. For example, specifically, a laser microscopic confocal Raman spectrometer (high-precision Renishaw laser microscopic confocal Raman spectrometer) is employed, and a 532 nm excitation wavelength is used. An appropriate amount of the positive electrode film layer is subjected to area mapping on the surface of the positive electrode film layer or the cross-section of the positive electrode film layer in the thickness direction of the electrode plate. The scanning area is set to 45 μm×45 μm and is divided into a 10×10 grid. Test points are located at grid vertices with a step size of 5 μm, and a total of 100 scan points are obtained. This yields C-values at distinct locations and the cumulative distribution curve of the C-value across the area-mapped region.

The positive electrode film layer in this application may be a freshly prepared positive electrode film layer, or may be a positive electrode film layer disassembled from a battery. Residual electrolyte salt particles inevitably exist on the surface of the positive electrode film layer disassembled from the battery. To improve the test accuracy, area mapping is preferably performed on the cross-section of the positive electrode film layer in the thickness direction of the electrode plate, thereby characterizing the graphitization degree of the positive electrode film layer.

The graphitization degree C value of the positive electrode film layer is obtained through the intensity ratio of the G-band to D-band in Raman spectra. The G-band, positioned at 1580±100 cm⁻, characterizes the carbon sp²-hybridized structure. The D-band, positioned at 1350±100 cm⁻¹, represents disordered structures. The “disorder” refers to the absence of a regular arrangement among carbon atoms in the structure. In graphite crystals, carbon atoms within the same layer form covalent bonds via sp² hybridization, while interlayer interactions are governed by van der Waals forces, facilitating slip of graphitic carbon. Therefore, the C value may characterize the graphitization degree of the positive electrode film layer. It may be understood that the graphitization degree in the positive electrode film layer mainly comes from the graphitized carbon material in the positive electrode film layer, i.e., the carbon material on the surface of the positive electrode active material. Although the conductive agent of carbon nanotubes rich in sp²-hybridized structure exhibits relatively high I_{G}/I_{D}, due to the low addition content and small tube diameter, the addition of the conductive agent of carbon nanotubes to the positive electrode film layer exhibits outliers in the Raman area mapping test of the positive electrode film layer, and does not affect the graphitization degree in the positive electrode film layer C₅₀. Therefore, the graphitization degree of the positive electrode film layer can also be configured to characterize the graphitization degree of the positive electrode active material.

The cumulative distribution curve of the graphitization degree C value is a curve obtained by sorting at least 100 obtained C values in ascending order and using the graphitization degree as a horizontal axis and the cumulative number percentage as a vertical axis. C₅₀ is a corresponding C value when the cumulative number percentage on the vertical axis of the cumulative distribution curve of the graphitization degree C value is 50%. The median C₅₀ of the graphitization degree can reflect the overall graphitization degree, i.e., the slip propensity, of particles in the positive electrode film layer compared with point values, and can reduce the impact of outliers during testing and improve the confidence level of test results compared with a mean value.

A person skilled in the art may achieve the regulation of the graphitization degree of particles of the active material through any known process. For example, the adjustment of the graphitization degree of the particles of the active material can be achieved by regulating carbon sources, sintering temperature, sintering duration, sintering pressure, and sintering atmosphere. When the graphitization degree of carbon on the surface of the positive electrode active material is higher, the proportion of graphitic carbon in the positive electrode film layer is higher, and it is easier for particles to slip through the carbon structure with a high graphitization degree on the surface of the particles of the active material, thereby mitigating the phenomenon of stress concentration in the electrode plate.

In some embodiments, in the cumulative distribution curve of the graphitization degree C value obtained from the positive electrode film layer in the area mapping mode of the laser microscopic confocal Raman spectrometer, the median C₅₀ of the graphitization degree is optionally 0.95, 0.96, 0.97, 0.98, 0.99, 1.00, 1.01, 1.02, 1.03, 1.04, 1.05, 1.06, 1.07, 1.08, 1.09, 1.10, 1.11, 1.12, 1.13, 1.14, 1.15, 1.16, 1.17, 1.18, 1.19, 1.20, or a value range between any two of the foregoing.

Research shows that the stress in the film layer extremely easily leads to an increase in the internal mechanical pressure under the effect of cyclic expansion, causing a failure in the encapsulation structure. The median C₅₀ of the graphitization degree in the cumulative distribution curve of the graphitization degree C value obtained from the positive electrode film layer in the area mapping mode of the laser microscopic confocal Raman spectrometer is controlled to range from 0.95 to 1.20, so that the graphitization degree of the positive electrode film layer is improved, the slip propensity of particles in the positive electrode film layer is improved, the phenomenon of stress concentration in the compaction process of the thick-coating film layer is reduced, and the degree of springback of the positive electrode film layer due to localized stress concentration during cycling is reduced, thereby improving the reliability of the battery cell while increasing the volumetric energy density of the battery cell.

In some embodiments, in a cumulative distribution curve of a coating value B obtained from the positive electrode film layer in the area mapping mode of the laser microscopic confocal Raman spectrometer, a median B₅₀ of the coating value ranges from 0.30 to 0.60, the coating value B is I_{P}/I_{D}, I_{P} represents the intensity of the P band at 948±100 cm⁻¹ in Raman spectra, and I_{D} represents the intensity of the D band at 1350±100 cm⁻¹ in Raman spectra.

In this application, the coating value B value of the positive electrode film layer may be obtained through mapping of the laser microscopic confocal Raman spectrometer. For example, specifically, a laser microscopic confocal Raman spectrometer (high-precision Renishaw laser microscopic confocal Raman spectrometer) is employed, and a 532 nm excitation wavelength is used. An appropriate amount of the positive electrode film layer is subjected to area mapping on the surface of the positive electrode film layer or the cross-section of the positive electrode film layer in the thickness direction of the electrode plate. The scanning area is set to 45 m×45 μm and is divided into a 10×10 grid. Test points are located at grid vertices with a step size of 5 μm, and a total of 100 scan points are obtained. This yields B-values at distinct locations and the cumulative distribution curve of the B-value across the area-mapped region.

The coating value B value of the positive electrode film layer is obtained through the intensity ratio of the P-band to D-band in Raman spectra. The P-band, positioned at 948±100 cm⁻¹, characterizes the phosphate radical PO₄³⁻ structure. The D-band, positioned at 1350±100 cm⁻¹, represents disordered structures. The “disorder” refers to the absence of a regular arrangement among carbon atoms in the structure. Raman spectroscopy is a surface analysis technique. Therefore, the carbon structure peak of the positive electrode film layer in the area mapping mode of the laser microscopic confocal Raman spectrometer exhibits higher strength compared with the higher-content phosphate radical structure peak in the bulk phase.

A person skilled in the art may achieve the regulation of the coating value of particles of the active material through any known process. For example, the adjustment of the coating value of the particles of the active material can be achieved by regulating carbon source types, carbon source addition amounts, sintering temperature, sintering duration, sintering pressure, and sintering atmosphere. The coating value B value can reflect the density of the carbon material on the surface of the lithium-containing transition metal phosphate particles. When the carbon material is denser, the strength of the phosphate radical structure detected in Raman spectra is lower, and the positive electrode film layer has a smaller coating value B value.

The cumulative distribution curve of the coating value B value is a curve obtained by sorting at least 100 obtained B values in ascending order and using the coating value as a horizontal axis and the cumulative number percentage as a vertical axis. B₅₀ is a corresponding B value when the cumulative number percentage on the vertical axis of the cumulative distribution curve of the coating value B value is 50%.

In some embodiments, in the cumulative distribution curve of the coating value B obtained from the positive electrode film layer in the area mapping mode of the laser microscopic confocal Raman spectrometer, the median B₅₀ of the coating value is optionally 0.3, 0.31, 0.32, 0.33, 0.34, 0.35, 0.355, 0.36, 0.368, 0.369, 0.37, 0.38, 0.39, 0.4, 0.41, 0.42, 0.43, 0.44, 0.446, 0.45, 0.456, 0.46, 0.47, 0.48, 0.49, 0.5, 0.51, 0.52, 0.53, 0.54, 0.55, 0.56, 0.57, 0.58, 0.59, 0.6, or a value range between any two of the foregoing.

To reduce the impact of the outliers of the coating value caused by non-particle region in the positive electrode film layer on the test results, the median B₅₀ of the coating value is used to evaluate the density of the carbon material on the surface of the positive electrode active material.

The median B₅₀ of the coating value of the positive electrode film layer is within the foregoing range, indicating that the carbon material on the surface of the positive electrode active material is dense and uniform, which is conducive to improving the slip uniformity of the positive electrode film layer in a rolling process, thereby reducing the phenomenon of stress concentration in the positive electrode film layer, reducing the degree of springback of the positive electrode plate, and improving the reliability of the battery cell.

In some embodiments, the lithium-containing transition metal phosphate particles include iron, and an iron dissolution rate of the positive electrode film layer ranges from 658 ppm to 1921 ppm, and optionally ranges from 658 ppm to 1485 ppm.

The iron dissolution rate of the positive electrode film layer may be tested in the following manner. Specifically, the electrode plate is disassembled from the battery, cleaned, and punched into discs with a diameter of 14 mm. Multiple disc samples with a total sample mass of approximately 5 g are taken, and are added to 100.3 g of a 0.3% mass concentration ascorbic acid solution (solvent: ultrapure water). The mixture is stirred at 500 revolutions per minute for 5 minutes. The solution is rapidly drawn using a 5 mL syringe. The solution is filtered through a 0.45 m pore-size filter into a test tube. 1 mL of the supernatant is pipetted into a glass volumetric flask and diluted 50-fold. The diluted solution is tested using inductively coupled plasma optical emission spectrometry (ICP-OES) to determine the iron concentration in the solution. The iron dissolution rate of the positive electrode film layer is calculated using the formula: [(ICP-measured iron concentration×solution volume/mass of solution used for dilution)×100.3 g]/(mass of electrode plate in disc−mass of current collector in disc)], where the solution volume is 50 mL and the mass of solution used for dilution is 1 g. Preferably, the mass of the current collector in the disc is obtained by multiplying the thickness by the area and then by the density of the disc. The thickness of the disc may be equivalently obtained by measuring the thickness of the current collector in an uncoated region using a thickness tester. It may be understood that although the current collector undergoes elongation in the coated region during compaction and as a result has a thickness slightly decreased compared with the uncoated region, because the decrease extent is ignorable, no significant impact is caused to test results.

In some embodiments, the lithium-containing transition metal phosphate particles include iron, and an iron dissolution rate of the positive electrode film layer may be 658 ppm, 700 ppm, 800 ppm, 890 ppm, 900 ppm, 1000 ppm, 1058 ppm, 1076 ppm, 1100 ppm, 1143 ppm, 1200 ppm, 1236 ppm, 1300 ppm, 1311 ppm, 1384 ppm, 1349 ppm, 1400 ppm, 1485 ppm, 1500 ppm, 1531 ppm, 1600 ppm, 1700 ppm, 1800 ppm, 1921 ppm, or a value range between any two of the foregoing.

Iron dissolved from the positive electrode film layer mainly comes from the lithium-containing transition metal phosphate of the positive electrode active material, and the magnitude of the iron dissolution rate depends on the number of lattice defects of the lithium-containing transition metal phosphate in one aspect, and depends on the integrity and density of the carbon material on the surface of the positive electrode active material in another aspect. When the iron dissolution rate is lower, the lithium-containing transition metal phosphate has fewer lattice defects, which is conducive to reducing the corrosion of lattices in a weak acid environment. In addition, when the carbon material on the surface of the positive electrode active material is more complete and denser, the dissolution of iron ions in a weak acid environment is inhibited. The positive electrode film layer with the iron dissolution rate falling within the foregoing range has a relatively small number of lattice defects, and the surface of the positive electrode active material has a complete and dense carbon material, which is conducive to improving the compression resistance and the slip propensity of the particles in the positive electrode film layer under large rolling pressure, thereby improving the compaction density of the positive electrode film layer and reducing the stress concentration in the positive electrode film layer, and improving the energy density of the battery while improving the reliability of the battery.

In some embodiments, the positive electrode film layer further includes a conductive agent, and based on a total area of the cross-section of the positive electrode film layer in the thickness direction of the electrode plate, a total area percentage of agglomeration regions of the conductive agent ranges from 0.5% to 2.5%.

In this application, the area percentage of the agglomeration regions of the conductive agent based on the total area of the cross-section of the positive electrode film layer in the thickness direction of the electrode plate may be tested using the following method. The cross-section of the positive electrode film layer in the thickness direction of the electrode plate is observed through a scanning electron microscope using a method similar to the above. The areas of the agglomeration regions of the conductive agent in the scanning electron micrograph are measured at a magnification of 3,000×. Because the conductive agent is usually a carbon-based material, for example, conductive carbon black, or carbon nanotubes, at a high rate of the scanning electron microscope, aggregation of the conductive agent can be seen. Compared with other regions in the positive electrode film layer, the agglomeration regions of the conductive agent usually exhibit a black agglomeration form. With image analysis software, the agglomeration regions of the conductive agent are regions in which the conductive agent clearly aggregates in the scanning electron micrograph, appearing as black regions. Specifically, the scanning electron micrograph at the magnification of 3,000× is imported into ImageJ. Black agglomeration regions of the conductive agent whose Feret is greater than or equal to 2 μm are selected, and a sum of the areas of the selected regions is calculated and denoted as the area of the agglomeration regions of the conductive agent. The area percentage of the agglomeration regions of the conductive agent is a ratio of the area of the agglomeration regions of the conductive agent to the total area of the imported scanning electron micrograph. Three scanning electron micrographs with nonoverlapping ranges are randomly taken, and a mean value of the area percentages of the agglomeration regions of the conductive agent is calculated as “the area percentage of the agglomeration regions of the conductive agent based on the total area of the cross-section of the positive electrode film layer in the thickness direction of the electrode plate”.

In some embodiments, the total area percentage of the agglomeration regions of the conductive agent based on the total area of the cross-section of the positive electrode film layer in the thickness direction of the electrode plate is optionally 0.5%, 0.6%, 0.7%, 0.8%, 0.9%, 1%, 1.1%, 1.2%, 1.3%, 1.4%, 1.5%, 1.6%, 1.68%, 1.7%, 1.8%, 1.9%, 2%, 2.1%, 2.2%, 2.3%, 2.4%, 2.41%, 2.5%, or a value range between any two of the foregoing.

The total area percentage of agglomeration regions of the conductive agent based on the total area of the cross-section of the positive electrode film layer in the thickness direction of the electrode plate ranges from 0.5% to 2.5%, indicating that the conductive agent in the positive electrode film layer is dispersed uniformly, which facilitates the formation of a uniform conductive network, and is especially conducive to mitigating the problem of kinetic degradation resulting from an elongated ion transport path in the thick-coating film layer, thereby mitigating localized polarization and even lithium plating issues of the battery during cycling.

In addition, research shows that large-dimension particles in the lithium-containing transition metal phosphate particles are prone to springback. When the agglomeration area of the conductive agent is within the foregoing range, the uniform distribution of the conductive agent can inhibit the springback of lithium-containing transition metal phosphate, and mechanical restraining is formed for the particles and even the film layer to improve the cohesive force of the film layer, thereby reducing the probability that the sealing zone fails, and improving the reliability of the battery.

In some embodiments, the positive electrode film layer further includes a conductive agent, and based on a total area of the cross-section of the positive electrode film layer in the thickness direction of the electrode plate, an area percentage of agglomeration regions of the conductive agent ranges from 0.5% to 1.7%.

In the embodiments of this application, the area percentage of the agglomeration regions of the conductive agent is further within the foregoing range, indicating that the conductive agent is distributed more uniformly in the positive electrode film layer, and the content of the conductive agent is low, so that while the kinetic performance of the positive electrode film layer is improved, the occupation of the space of the positive electrode active material by the excessive conductive agent is reduced, thereby further improving the volumetric energy density of the battery while improving the kinetic performance of the battery.

In some embodiments, the conductive agent includes carbon nanotubes, and the carbon nanotubes include one or more of single-walled carbon nanotubes, few-walled carbon nanotubes, and multi-walled carbon nanotubes.

In this application, the term “carbon nanotubes” refers to a nanomaterial including several to dozens of layers concentric hollow tubes, formed by rolling up graphene sheets composed of carbon atoms bonded via sp² hybridization. The diameter usually ranges from several to dozens of nanometers, and the length may range from several micrometers to centimeters, exhibiting a length-diameter ratio. Based on the number of graphene sheets, carbon nanotubes may be classified into single-walled carbon nanotubes (SWCNTs), few-walled carbon nanotubes (FWCNTs), and multi-walled carbon nanotubes (MWCNTs). Based on the number of graphene sheets, carbon nanotubes may be classified into single-walled carbon nanotubes (SWCNTs), few-walled carbon nanotubes (FWCNTs), and multi-walled carbon nanotubes (MWCNTs).

Carbon nanotubes have the structural characteristic of a high length-diameter ratio, which is conducive to forming a long-range conductive path between a plurality of positive particles lapped in the thickness direction and improving the restraining force between particles, so that the kinetic performance of the thick-coating positive electrode film layer is improved to mitigate localized polarization and even lithium plating issues of the battery during cycling, thereby improving the cycle life of the battery, and a network structure can be formed in the positive electrode film layer for use as a bridge for stress propagation to effectively mitigate stress concentration and reduce the degree of springback of the electrode plate, thereby improving the reliability of the battery cell.

In addition, carbon nanotubes have a high specific surface area and a hollow structure, thereby further providing an excellent liquid retention capability. A thick electrode plate has a large expansion force during cycling, making the electrolyte easy to be extruded, and carbon nanotubes are conducive to improving the liquid retention capability of the thick electrode plate in the positive electrode film layer, thereby mitigating a capacity cliff of the battery cell during cycling, and improving the cycle life of the battery cell.

In some embodiments, the conductive agent further includes conductive carbon black.

Conductive carbon black has a high specific surface area, thereby further providing an excellent liquid retention capability. A thick electrode plate has a large expansion force during cycling, making the electrolyte easy to be extruded, and the distribution of conductive carbon black in the positive electrode film layer is conducive to improving the liquid retention capability of the thick electrode plate, thereby mitigating a capacity cliff of the battery during cycling, and improving the cycle life of the battery.

In some embodiments, the agglomeration regions of the conductive agent include carbon nanotubes and conductive carbon black.

Researchers find that carbon nanotubes are prone to an agglomeration phenomenon due to the high surface energy of carbon nanotubes. As a result, the dispersion of carbon nanotubes in the positive electrode film layer is nonuniform, and an effective network structure of carbon nanotubes fails to be formed. Conductive carbon black has surface energy close to that of carbon nanotubes and can be adsorbed on the surface of carbon nanotubes to form a physical barrier, to increase the resistance against the agglomeration of carbon nanotubes and reduce direct contact between carbon nanotubes, thereby further inhibiting the agglomeration phenomenon and improving the distribution uniformity of carbon nanotubes in the positive electrode film layer. This is conducive to improving the conductivity of the thick-coating positive electrode film layer in one aspect, thereby improving the kinetic performance of the battery, and is conducive to exerting the function of restraining carbon nanotubes on the positive electrode film layer in another aspect, thereby reducing the risk that the thick-coating positive electrode film layer falls off, and further improving the kinetic performance and cycle life of the battery. In addition, the agglomeration of carbon nanotubes in the agglomeration regions of the conductive agent further leads to congestion in a localized ion transport path in the agglomeration regions of the conductive agent, and the combination with conductive carbon black can improve the lithium ion transport capability in the region, thereby reducing localized polarization, and further improving the cycle stability of the battery.

In some embodiments, based on a mass of the positive electrode film layer, a mass content C1 of the carbon nanotubes meets: 0<C1≤2.5%, and a mass content C2 of the conductive carbon black meets: 0<C1≤2.5%.

In some embodiments, based on the mass of the positive electrode film layer, the mass content C1 of the carbon nanotubes is optionally 0.1%, 0.2%, 0.3%, 0.4%, 0.5%, 0.6%, 0.67%, 0.7%, 0.8%, 0.9%, 1.0%, 1.1%, 1.2%, 1.3%, 1.4%, 1.5%, 1.6%, 1.7%, 1.8%, 1.9%, 2.0%, 2.1%, 2.2%, 2.3%, 2.4%, 2.5%, or a value range between any two of the foregoing.

In some embodiments, based on the mass of the positive electrode film layer, the mass content C2 of the conductive carbon black is optionally 0.1%, 0.2%, 0.3%, 0.4%, 0.5%, 0.6%, 0.7%, 0.8%, 0.9%, 1.0%, 1.1%, 1.2%, 1.3%, 1.4%, 1.5%, 1.6%, 1.7%, 1.8%, 1.9%, 2.0%, 2.1%, 2.2%, 2.3%, 2.4%, 2.5%, or a value range between any two of the foregoing.

The mass contents of carbon nanotubes and conductive carbon black in the positive electrode film layer fall within the foregoing ranges, so that the agglomeration phenomenon of carbon nanotubes can be effectively mitigated and an excellent conductive network structure can be formed, to effectively alleviate springback in the thick-coating positive electrode film layer, thereby improving the reliability of the battery cell; and the liquid retention rate of the positive electrode plate during long cycling is increased to reduce a polarization degree, thereby mitigating the capacity cliff issue of the battery cell.

In some embodiments, the positive electrode film layer further includes a dispersant, and the dispersant includes hydrogenated nitrile butadiene rubber HNBR.

HNBR is obtained by hydrogenating butyronitrile rubber to saturate the double bonds. The highly saturated backbone structure of HNBR provides excellent oil resistance, heat resistance, aging resistance, and the like. This enables HNBR to maintain stability as a dispersant in diverse environments and systems, resisting degradation or deterioration while effectively performing the dispersion function. The HNBR molecular chain contains both polar nitrile groups and nonpolar hydrocarbon segments. The polar nitrile groups can interact with hydroxyl groups (—OH) or metal oxide sites on the surface of lithium-containing transition metal phosphate particles (for example, through hydrogen bonding or dipole interactions), enhancing particle-solvent compatibility and reducing interfacial tension between the particles and the solvent, especially interfacial tension with large particles, so that the uniform dispersion of the particles are promoted, aggregation caused by hydrophobicity is reduced, and the dispersion of large particles in the positive electrode film layer is improved, thereby reducing stress concentration induced by springback. The nonpolar hydrocarbon segments have excellent lipophilicity, enabling excellent extension and dispersion in nonpolar or weakly polar media, thereby facilitating uniform dispersion of particles in the media.

After HNBR is adsorbed on the surface of particles in slurry, the long-chain molecules of HNBR form a physical barrier layer around the particles to keep the particles from approaching each other and aggregating, thereby maintaining a relatively independent dispersed state of the particles in the system. In addition, HNBR can reduce the surface tension between the dispersion media and the dispersed particles, making the particles easier to be wetted by the media, thereby promoting the dispersion of the particles in the media. In addition, the interfacial energy between particles, especially, the aggregation phenomenon of the conductive agent driven by interfacial energy, can be further reduced, thereby improving the cycle life of the battery cell.

In some embodiments, based on the mass of the positive electrode film layer, a mass content of the dispersant ranges from 0.5% to 2%.

In some embodiments, based on the mass of the positive electrode film layer, the mass content of the dispersant is optionally 0.5%, 0.6%, 0.7%, 0.8%, 0.9%, 1%, 1.5%, 2%, or a value range between any two of the foregoing.

The mass content of the dispersant is within the foregoing range, so that the uniform dispersion of particles in the positive electrode film layer can be achieved while maintaining the high load amount of the positive electrode film layer, to mitigate springback caused by stress concentration in the positive electrode film layer of the thick-coating lithium-containing transition metal phosphate, thereby reducing the springback rate of the positive electrode film layer, and improving the reliability of the battery cell.

In some embodiments, a porosity of the positive electrode film layer ranges from 14% to 28%.

In this application, the porosity of the positive electrode film layer may be tested in the following manner. The scanning electron micrograph of the cross-section of the positive electrode film layer in the thickness direction of the electrode plate obtained in the manner described above is imported into the ImageJ software, Straight Line Tool is selected, use a straight line to mark the scale bar length in the image, and “Analyze Set Scale” is clicked, and a scale bar parameter is set in the software based on the scale bar length in the image. Rectangle Tool is selected to choose the part of the image excluding the scale bar region, “Image Duplicate” is used to duplicate the chosen region, and “Image Type 8 bit” is used to adjust the format of the image. “Analyze Set Measurements” is selected to select the following five options: “Area”, “Mean gray value”, “Area Fraction”, “Limit to threshold”, and “Feret's diameter”. “3” is selected for “Decimal places”, and “Image”, “Adjust”, and “Threshold” are sequentially selected. 0 and 100 are sequentially set within the “Threshold” dialog box, so that pore data in the electron micrograph of the cross-section can be exported using the Analyze-Measure function. “Image”, “Overlay”, and “Flatten” are used to export a pore image. “Apply” in “Threshold” is clicked, and then “Analyze” and “Analyze Particles” are clicked to check four columns on the left side, so that the statistical data of pores can be obtained.

It may be understood that a “pore” in the cross-section of the positive electrode film layer is identified through image chromatic aberration and thresholds in the embodiments of this application. The “pores” do not represent porosity data obtained from gas expansion tests, and primarily characterize the cross-sectional area between particles in the cross-section of the positive electrode film layer. This method is superior to the gas expansion method because the porosity obtained from the gas expansion method is associated with inter-particle pores, and is also associated with the pores in the carbon material on the surface of lithium iron phosphate particles, thereby failing to objectively reflect inter-particle porosity.

The porosity of the positive electrode film layer is within the foregoing range, so that in one aspect, the liquid retention characteristic of the electrolyte is improved, and the ionic diffusibility of the thick-coating electrode plate and positive electrode film layer is improved, thereby improving the kinetic performance of the battery, and in another aspect, springback or a volume increase in a charge-discharge process can be cushioned to reduce the impact of the expansion stress on the sealing zone, thereby maintaining the high reliability of the battery.

In some embodiments, the porosity of the positive electrode film layer is optionally 14%, 15%, 16%, 17%, 18%, 19%, 20%, 21%, 22%, 23%, 24%, 25%, 26%, 27%, 28%, or a value range between any two of the foregoing.

In some embodiments, as shown in FIG. 2, the battery cell further includes a separator 20 disposed between the positive electrode plate and the negative electrode plate, the separator 20 includes a base film 201, a ceramic layer 202 disposed on each of two sides of the base film 201, and a bonding layer 203 disposed on a side of the ceramic layer 202 on at least one side away from the base film 201, the bonding layer 203 is a continuous layer with a porous structure, and the bonding layer 203 includes a vinylidene fluoride polymer.

In some embodiments, a vinylidene fluoride-based polymer includes one or more of polyvinylidene fluoride (PVDF) and polyvinylidene fluoride-hexafluoropropylene copolymer (PVDF-HFP).

In some embodiments, the vinylidene fluoride-based polymer includes polyvinylidene fluoride (PVDF).

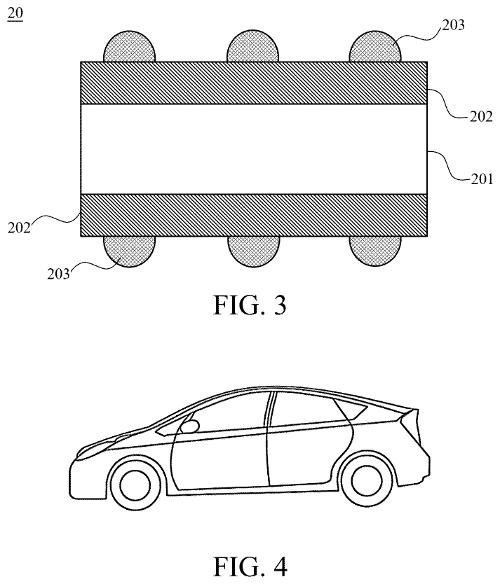

As shown in FIG. 3, the bonding layer of the separator in existing technologies often uses water-based PVDF, and exhibits an island-like structure in the separator. This is conducive to providing gaps for the expansion of the electrode assembly in one aspect, and in one aspect facilitates manufacturing. However, this bonding layer of the separator has a small contact area with the electrode plate, and the bonding force is weak.

The separator provided in the embodiments of this application uses the continuous layer with the porous structure as the bonding layer, and as shown in FIG. 2, has a larger bonding area with the electrode plate compared with the bonding layer in existing technologies, making the bonding between the separator and the electrode plate more secure and uniform, which is further conducive to maintaining the interface contact between the separator and the positive electrode film layer during springback in the positive electrode film layer, thereby reducing the probability that the film layer falls off.

It may be understood that the continuous bonding layer may fracture due to contact or compression with the positive electrode plate or the negative electrode plate and deform into block structures in an manufacturing or cycling process of the electrode plates. The continuous structure in this application refers to that the bonding layer of the separator is continuous on a microscopic level, for example, as observed under a scanning electron microscope or an optical microscope. To reflect the actual morphology of the separator, during sampling, sampling is preferably performed in a region in which the bonding layer of the separator is not bonded to the positive electrode plate or the negative electrode plate in the battery. For example, sampling is performed at a separator position protruding from the positive electrode plate and the negative electrode plate, or sampling is performed at a separator close to the surface of the electrode assembly. The bonding between the sampling region of the separator and the positive electrode plate or the negative electrode plate is low, and the actual state of the separator can be better reflected.

The separator provided in the embodiments of this application uses the continuous layer with the porous structure as the bonding layer, which has a larger bonding area compared with a bonding layer in existing technologies, so that the bonding between the separator and the positive electrode film layer is more secure and uniform. The particles whose particle size R1 meets R1≥1000 nm is prone to stress concentration during cycling to cause springback issues. The separator provided in the embodiments of this application uses the continuous layer with the porous structure as the bonding layer, and is especially applicable to a thick-coating stacked electrode assembly, to mitigate the springback phenomenon of the thick-coating stacked electrode assembly during long cycling, thereby reducing the expansion stress inside the battery, and improving the overall reliability of the sealing zone and the battery cell. Additionally, the thick-coating electrode assembly is prone to a relative displacement between the electrode plate and the separator in a process of dragging an outer-layer electrode plate and soldering a tab, so that the film layer is prone to powder falling or even lapping between the positive and negative electrodes to cause the risk of an internal short-circuit. The use of the continuous layer with the porous structure in the embodiments of this application as the bonding layer can also lower the foregoing risk.

In some embodiments, the material of the base film may include, but is not limited to, one or more of glass fiber, non-woven fabric, polyethylene (PE), and polypropylene (PP).

In some embodiments, the ceramic layer includes one or more of aluminum oxide (Al₂O₃), zirconium oxide (ZrO₂), titanium oxide (TiO₂), silicon oxide (SiO₂), and boron nitride (BN).

Ceramic particles exhibit flame retardancy and high hardness values, demonstrating minimal deformation under thermal stress, thereby exhibiting excellent dimensional stability. The low thermal conductivity of ceramic materials can further prevent localized thermal runaway points in the battery from escalating into full-scale thermal runaway, thereby enhancing the safety performance of the battery cell.

In some embodiments, a base coating layer is disposed in a bottom region of the positive electrode film layer close to the positive electrode current collector, and the base coating layer includes a conductive agent and a binder, the conductive agent includes carbon nanotubes and conductive carbon black, and the binder includes a vinylidene fluoride polymer.

In some embodiments, a base coating layer is disposed in a bottom region of the positive electrode film layer close to the positive electrode current collector, and a thickness of the base coating layer ranges from 0.5 μm to 5 μm.

In some embodiments, the thickness of the base coating layer is optionally 0.5 μm, 1 μm, 1.5 μm, 2 μm, 2.5 μm, 3 μm, 3.5 μm, 4 μm, 4.5 μm, 5 μm, or a value range between any two of the foregoing.

The base coating layer provided in the embodiments of this application is conducive to improving the bonding force between the positive electrode film layer and the positive electrode current collector and mitigating the phenomenon of stress concentration at large particles, thereby reducing the springback of the positive electrode film layer, and improving the reliability of the battery cell. In addition, compared with the direct contact between the positive electrode current collector and the positive electrode film layer, the contact area between the base coating layer and the positive electrode film layer is increased, which is conducive to increasing an electron transport area between the current collector and the positive electrode film layer, thereby reducing the internal resistance of the electrode plate, and improving the kinetic performance of the battery.

In some embodiments, the lithium-containing transition metal phosphate particles in the positive electrode film layer include a component shown in the following general formula:

LiₘFeₓP_{y}OⱼQ_{q} Formula I,
where Q includes one or more of Al, Na, K, Mg, Cu, Mn, Cr, Zn, Pb, Ca, Co, Ni, Sr, Nb, V, Ti, B, S, Si, N, F, Cl, Br, 0.8≤m≤1.15, 0.9≤x≤1, 0.95≤y≤1, 3.5≤j≤4, and 0≤q≤0.1.

In some embodiments, m is optionally 0.8, 0.85, 0.9, 0.95, 0.98, 1.00, 1.03, 1.05, 1.08, 1.10, 1.13, 1.15, or a value range between any two of the foregoing; x is optionally 0.9, 0.91, 0.92, 0.93, 0.94, 0.95, 0.96, 0.97, 0.98, 0.99, 1.0, or a value range between any two of the foregoing; y is optionally 0.95, 0.96, 0.97, 0.98, 0.99, 1.00, or a value range between any two of the foregoing; j is optionally 3.5, 3.6, 3.7, 3.8, 3.9, 4, or a value range between any two of the foregoing; and q is optionally 0, 0.01, 0.02, 0.03, 0.04, 0.05, 0.06, 0.07, 0.08, 0.09, 0.1, or a value range between any two of the foregoing.

The selection of a suitable modification element Q can improve a lattice change rate of the positive electrode active material in a lithium deintercalation and intercalation process and reduce the oxygen reactivity on the surface of the particles, to improve the structural stability of the material, thereby further improving the specific capacity utilization of the material during cycling, and improving the cycle stability of the battery cell.

In some embodiments, the lithium-containing transition metal phosphate particles include titanium, and based on a total mass of the lithium-containing transition metal phosphate particles in the positive electrode film layer, a mass content of titanium ranges from 500 ppm to 8000 ppm, and optionally ranges from 1000 ppm to 3000 ppm.

The types and contents of the elements in the lithium-containing transition metal phosphate particles in the positive electrode film layer may be detected in any manner known in the field. For example, titanium and its content are tested using inductively coupled plasma optical emission spectrometry (ICP-OES) in accordance with Appendix C of GB/T 33822-2017.

In some embodiments, based on the total mass of the lithium-containing transition metal phosphate particles in the positive electrode film layer, the mass content of titanium is optionally 500 ppm, 600 ppm, 700 ppm, 800 ppm, 900 ppm, 1000 ppm, 1100 ppm, 1200 ppm, 1400 ppm, 1500 ppm, 1600 ppm, 1700 ppm, 1800 ppm, 1900 ppm, 2000 ppm, 2100 ppm, 2200 ppm, 2300 ppm, 2400 ppm, 2500 ppm, 2600 ppm, 2700 ppm, 2800 ppm, 2900 ppm, 3000 ppm, 3500 ppm, 4000 ppm, 4500 ppm, 5000 ppm, 5500 ppm, 6000 ppm, 6500 ppm, 7000 ppm, 7500 ppm, 8000 ppm, or a value range between any two of the foregoing.

To introduce titanium into the lithium-containing transition metal phosphate particles, a titanium source needs to be added in a process of preparing the positive electrode active material. The titanium source is usually an inert material, and can achieve the functions of reducing reactivity and suppressing particle dimension growth after being adhered to the surface of lithium-containing transition metal phosphate precursors. To improve the graphitization degree of the positive electrode active material, high sintering temperatures or long sintering durations are usually required. However, this also increases the dimensions of the particles in the positive electrode film layer and increases stress concentration of the positive electrode film layer, leading to the falling off of the positive electrode film layer. In the embodiments of this application, high-content titanium is added to the lithium-containing transition metal phosphate particles, so that the reactivity of synthetic precursors of the positive electrode active material are reduced, and the percentage of large particles is controlled while the positive electrode active material has a high graphitization degree, to reduce the springback rate of the positive electrode film layer, thereby improving the energy density of the battery while maintaining the reliability of the battery.

In addition, the doping of titanium in the positive electrode active material is conducive to inducing lattice distortion and reducing Li—O bond energy, thereby increasing the transport rate of lithium ions, and improving the kinetic performance of the battery. The diffusion of lithium ions in the thick-coating film layer is not uniform, and is usually accompanied with a significant lithium ionic concentration gradient. In the embodiments of this application, high-content titanium is added to the lithium-containing transition metal phosphate particles to increase a solid-phase transport rate of the positive electrode active material, thereby mitigating the kinetic issues of the battery with the thick electrode plate.

In some embodiments, the lithium-containing transition metal phosphate particles include vanadium, and based on the total mass of the lithium-containing transition metal phosphate particles in the positive electrode film layer, a mass content of vanadium ranges from 500 ppm to 5000 ppm, and optionally ranges from 500 ppm to 3000 ppm.

In some embodiments, based on the total mass of the lithium-containing transition metal phosphate particles in the positive electrode film layer, the mass content of vanadium is optionally 500 ppm, 600 ppm, 700 ppm, 800 ppm, 900 ppm, 1000 ppm, 1100 ppm, 1200 ppm, 1400 ppm, 1500 ppm, 1600 ppm, 1700 ppm, 1800 ppm, 1900 ppm, 2000 ppm, 2100 ppm, 2200 ppm, 2300 ppm, 2400 ppm, 2500 ppm, 2600 ppm, 2700 ppm, 2800 ppm, 2900 ppm, 3000 ppm, 3500 ppm, 4000 ppm, 4500 ppm, or 5000 ppm.

Vanadium in the positive electrode film layer can exist in multiple valence states. Pentavalent vanadium (V⁵⁺) can be doped at phosphorus sites, and can induce lattice distortion due to its large radius, expanding lithium-ion diffusion channels, thereby improving the ion conductivity of the positive electrode active material, and improving the kinetic performance of the battery. Trivalent vanadium (V³⁺) may be doped at transition metal sites, generating lithium vacancies through charge compensation, thereby improving the electron conductivity of the positive electrode active material. In addition, the distribution uniformity of vanadium in the lithium-containing transition metal phosphate particles is improved, which is conducive to further improving the kinetic performance of the positive electrode film layer and the reaction uniformity of the positive electrode film layer, thereby improving the kinetic performance and the cycle performance of the battery cell.

The mass content of vanadium is within the foregoing range, which is conducive to improving the kinetic performance of the positive electrode plate, thereby improving the kinetic performance of the battery with thick-coating lithium-containing transition metal phosphate. In addition, the collaboration of titanium, vanadium, and carbon nanotubes in the positive electrode film layer is conducive to forming an excellent three-dimensional network, to further improve the electron conductivity and the ion conductivity of the positive electrode film layer, thereby further improving the kinetic performance of the battery with thick-coating lithium-containing transition metal phosphate.

In some embodiments, the lithium-containing transition metal phosphate of the positive electrode film layer includes one or more of lithium iron phosphate, lithium manganese phosphate, lithium vanadium fluorophosphate, lithium manganese iron phosphate, and a modified material thereof.

In some embodiments, the lithium-containing transition metal phosphate of the positive electrode film layer includes one or more of lithium iron phosphate, a doped modified material thereof, and a coated modified material thereof.

The material of lithium-containing transition metal phosphate exhibits excellent thermal stability, cycle stability, and the like, and is conducive to improving the safety performance and cycle performance of the battery.

In some embodiments, the pouch-type material includes an aluminum laminate composite film, and optionally, includes a composite film formed by aluminum and one or more of aluminum, polypropylene (PP), polybutylene terephthalate (PBT), polybutylene succinate (PBS), nylon, polyethylene terephthalate (PET), and polyethylene (PE).

Compared with hard shell materials such as an aluminum shell and a steel shell, the pouch-type material has a light mass, which is conducive to further improving the energy density of the battery with lithium-containing transition metal phosphate.

In some embodiments, at least one stacked electrode assembly is accommodated in the housing, a dimension of the housing in the length direction is L₀, a dimension of the housing in the width direction is W₀, a dimension of the housing in the thickness direction is H₀, 450 mm≤L₀≤1300 mm, 100 mm≤W₀≤150 mm, and 14 mm≤H₀≤22 mm.

In some embodiments, L₀ is optionally 450 mm, 460 mm, 470 mm, 480 mm, 490 mm, 500 mm, 510 mm, 520 mm, 530 mm, 540 mm, 550 mm, 560 mm, 570 mm, 580 mm, 590 mm, 600 mm, 610 mm, 620 mm, 630 mm, 640 mm, 650 mm, 660 mm, 670 mm, 680 mm, 690 mm, 700 mm, 710 mm, 720 mm, 750 mm, 800 mm, 850 mm, 900 mm, 950 mm, 1000 mm, 1050 mm, 1100 mm, 1150 mm, 1200 mm, 1250 mm, 1300 mm, or a value range between any two of the foregoing.

In some embodiments, W₀ is optionally 100 mm, 110 mm, 120 mm, 130 mm, 140 mm, 150 mm, or a value range between any two of the foregoing.

In some embodiments, H₀ is optionally 14 mm, 15 mm, 16 mm, 17 mm, 18 mm, 19 mm, 20 mm, 21 mm, 22 mm, or a value range between any two of the foregoing.

In some embodiments, the dimension L₀ of the housing in the length direction meets: 450 mm≤L₀≤650 mm.

When the dimension L₀ of the housing in the length direction meets 450 mm≤L₀≤650 mm, the length of the battery cell is small, which is conducive to shortening a diffusion path for current, to reduce the internal resistance of the electrode plate, thereby reducing the heat generation of the battery and improving the kinetic performance of the battery. In addition, the small length of the housing is conducive to shortening a diffusion path for the electrolyte during infiltration, to increase the infiltration rate and uniformity of the electrolyte, thereby further promoting deintercalation and intercalation uniformity of lithium ions during cycling, mitigating the phenomenon of stress concentration, reducing the extent of springback of the film layer, and improving the reliability of the battery cell.

In some embodiments, the dimension L₀ of the housing in the length direction meets: 900 mm≤L₀≤1300 mm.

When the dimension L₀ of the housing in the length direction meets 900 mm≤L₀≤1300 mm, the dimension of the battery cell is large, which is conducive to reducing the volume percentage of the housing in the battery cell, thereby increasing the load percentage of the active material. In addition, the long battery cell can reduce the number of batteries required in a battery module, to simplify the structural design of the battery module, and reduce the number and complexity of the structural members in the module, thereby improving the space utilization of a battery pack, and further increasing the volumetric energy density of the battery cell.

In some embodiments, at 25 °C, a capacity of the battery cell ranges from 105 Ah to 300 Ah, and optionally ranges from 150 Ah to 190 Ah.

In this application, the capacity of the battery cell has a meaning well-known in the art, and can be tested by using a method known in the art. For example, the battery is charged at a charging rate of 0.5 C based on the nominal capacity until the voltage reaches 3.65 V, followed by constant-voltage charging at 3.65 V until the current drops to 0.05 C. After a 10-minute rest, the battery is discharged at a discharging rate of 1 C until the voltage drops to 2.5 V, followed by another 10-minute rest. The discharge capacity (in Ah) is calculated using the formula C=I×t.

In some embodiments, at 25 °C, the capacity of the battery cell is optionally 125 Ah, 130 Ah, 135 Ah, 140 Ah, 145 Ah, 150 Ah, 155 Ah, 160 Ah, 165 Ah, 170 Ah, 175 Ah, 180 Ah, 185 Ah, 190 Ah, 200 Ah, 210 Ah, 220 Ah, 230 Ah, 240 Ah, 250 Ah, 260 Ah, 270 Ah, 280 Ah, 290 Ah, 300 Ah, or a value range between any two of the foregoing.

In some implementations, the positive electrode current collector may use a metal foil or a composite current collector. For example, as a metal foil, aluminum foil may be used. The composite current collector can include a polymer material substrate and a metal layer formed on at least one surface of the polymer material substrate. The composite current collector may be formed by forming a metal material (aluminum, an aluminum alloy, nickel, a nickel alloy, titanium, a titanium alloy, silver, a silver alloy, or the like) on a polymer material substrate (for example, a substrate of polypropylene (PP), polyethylene terephthalate (PET), polybutylene terephthalate (PBT), polystyrene (PS), or polyethylene (PE)).

In some implementations, the negative electrode current collector may use a metal foil or a composite current collector. For example, as a metal foil, copper foil may be used. The composite current collector can include a polymer material substrate and a metal layer formed on at least one surface of the polymer material substrate. The composite current collector can be formed by forming a metal material (copper, copper alloy, nickel, nickel alloy, titanium, titanium alloy, silver and silver alloy, etc.) on a high molecular material substrate (such as polypropylene (PP), polyethylene terephthalate (PET), polybutylene terephthalate (PBT), polystyrene (PS), and polyethylene (PE)).

In some embodiments, the negative electrode film layer includes a negative electrode active material. As an example, the negative electrode active material may include at least one of the following materials: artificial graphite, natural graphite, soft carbon, and hard carbon. However, this application is not limited to such materials, and may alternatively use other conventional materials that can be used as negative electrode active materials for batteries. Only one or a combination of two or more of these negative electrode active materials may be used.

In some implementations, the negative electrode film layer optionally includes a binder. The binder may be at least one selected from styrene-butadiene rubber (SBR), polyacrylic acid (PAA), polyacrylic acid sodium (PAAS), polyacrylamide (PAM), polyvinyl alcohol (PVA), sodium alginate (SA), poly(methyl methacrylate) (PMAA), and carboxymethyl chitosan (CMCS).

In some implementations, the negative electrode film layer optionally includes a conductive agent. The conductive agent may be selected from at least one of superconducting carbon, acetylene black, carbon black, Ketjen black, carbon dots, carbon nanotubes, graphene, and carbon nanofibers.

In some implementations, the negative electrode film layer optionally includes another adjuvant such as a thickener (for example, sodium carboxymethyl cellulose (CMC-Na)).

In some implementations, the negative electrode plate may be prepared in the following manner: dispersing components for preparing the negative electrode plate, for example, a negative electrode active material, a conductive agent, a binder, and any other components into a solvent (for example, deionized water) to form negative electrode slurry; coating the negative electrode slurry on the negative electrode current collector to obtain the negative electrode plate subsequent to procedures such as drying and compaction.

A second aspect of this application provides a battery apparatus, including the battery cell provided in the first aspect of this application.

The battery apparatus disclosed in the embodiments of this application may be used in a power consuming device that uses a battery apparatus as a power supply or used in various energy storage systems that use a battery apparatus as an energy storage element. The battery apparatus may be used in a vehicle, and may further be used in, but is not limited to, a mobile phone, a tablet computer, a laptop computer, an electric toy, an electric tool, an electric scooter, an electric vehicle, a ship, spacecraft, or the like. The electric toy may be a stationary or mobile electric toy, for example, a game console, an electric vehicle toy, an electric ship toy, or an electric aircraft toy. The spacecraft may include an airplane, a rocket, a space shuttle, a spaceship, and the like.

In addition, this application further provides a power consuming device that uses a battery apparatus as a power supply. The power consuming device includes at least one of the battery cell, the battery module, or the battery pack provided in this application. The battery cell, the battery module, or the battery pack may be used as a power supply of the power consuming apparatus or may be used as an energy storage unit of the power consuming apparatus.

The battery cell, the battery module, or the battery pack may be selected according to use requirements of the power consuming apparatus.

FIG. 4 shows an example of a power consuming device. The power consuming device disclosed in the embodiments of this application may be a fuel powered vehicle, a gas powered vehicle, or a new energy vehicle. The new energy vehicle may be a pure electric vehicle, a hybrid electric vehicle, or an extended range vehicle, etc. A battery apparatus is provided inside the vehicle. The battery apparatus may be disposed at the bottom, head, or tail of the vehicle. The battery apparatus may be configured to supply power to the vehicle. For example, the battery apparatus may be used as a power source for operating the vehicle. The vehicle may further include a controller and a motor. The controller is configured to control the battery apparatus to supply power to the motor, for example, to meet working power requirements during starting, navigation, and traveling of the vehicle. In some embodiments of this application, the battery apparatus can not only serve as a power supply for operating the vehicle, but can also serve as a power supply for driving the vehicle, in place of or partially in place of fuel or natural gas, to provide driving power for the vehicle.

Embodiments of this application further provide an energy storage apparatus that uses a battery apparatus as a power supply. The energy storage apparatus may be, but is not limited to, an energy storage container, an energy storage cabinet, an energy storage power station, an energy storage battery pack, or a portable energy storage system.

### EXAMPLES

Examples of this application will be described hereinafter. The examples described below are exemplary and only used to explain this application, and should not be construed as a limitation on this application. If the specific technology or conditions are not specified in the examples, the technology or conditions described in the literature in this field or the product manual shall be followed. The used reagents or instruments without manufacturer indicated are all conventional products that may be purchased in the market.

### Example 1

### (1). Manufacturing of a Positive Electrode Active Material

Lithium carbonate, ferric phosphate, titanium dioxide, vanadium pentoxide, sucrose, glucose, and polyethylene glycol were added to deionized water and mixed in a premixing tank. The ratio of lithium carbonate to ferric phosphate was controlled to achieve a lithium-to-iron molar ratio of 1.025:1.0. Based on the total mass of the mixed raw materials, the mass content of sucrose is 2%, the mass content of glucose is 4%, and the mass content of polyethylene glycol is 5%. After thorough mixing, mixed raw materials with a solid content of 38% was obtained.

The particle size Dᵥ₅₀ of lithium carbonate is 6 μm; ferric phosphate particles exhibit a quasi-spherical morphology; both titanium dioxide and vanadium pentoxide are nanoparticles; sucrose has a purity ≥98%; the moisture mass content of glucose is <0.5%; and the weight-average molecular weight of polyethylene glycol is 1500.

The mixed raw materials underwent a two-stage grinding process in a sand mill: coarse grinding for 1 h followed by fine grinding. Throughout grinding, the slurry temperature was controlled below 40 °C to obtain mixed slurry. The particle size D₅₀ of solid particles in the mixed slurry is 0.45 μm. The slurry was then spray-dried to yield dried precursor powder, which exhibits a particle size D₅₀ of 55.55 m after drying.

The precursor powder underwent a two-stage sintering process under nitrogen atmosphere to obtain the positive electrode active material: In a first heating stage, the temperature was raised from 25 °C to 450 °C at a heating rate of 2 °C/min and maintained for 3 h. In a second heating stage, the temperature was raised from 450 °C to 780 °C at a heating rate of 5 °C/min and maintained for 12 h. The ratio of the gas flow rate during the heating stages to that during the constant-temperature stages is 1.5:1, with a total gas flow rate of 1350 cm³/h. After sintering, the material was cooled and subjected to airflow pulverization to yield the positive electrode active material of lithium iron phosphate with a carbon material coated on the surface, exhibiting the particle size D₅₀ of 1.65 μm. Based on the total mass of the positive electrode active material, the mass content of Ti is 1050 ppm, and the mass content of V is 950 ppm.

D₅₀ and Dᵥ₅₀ are data tested using a Malvern laser scattering method.

### (2) Manufacturing of a Positive Electrode Plate

The positive electrode active material, conductive agent, and polyvinylidene fluoride binder were mixed in a mass ratio of 95:2:3 using N-methylpyrrolidone as the solvent. The mixture was thoroughly blended, stirred, and dispersed in a stirring tank to form positive electrode slurry. Upon completion of the stirring process, the positive electrode slurry was transferred to the coating process. The conductive agent consists of conductive carbon black and multi-walled carbon nanotubes in a 1:1 mass ratio. The carbon black exhibits a specific surface area of 80 m²/g and an oil absorption value of 180 mL/100 g, and the carbon nanotubes have an average length of 20 μm and a specific surface area of 280 m²/g.

The positive electrode slurry was transfer-coated onto an aluminum foil for drying, and hot pressing is performed to obtain a positive electrode plate with a single-side thickness of 106.9 μm and a positive electrode plate with a compaction density of 2.35 g/cm³ of the positive electrode film layer. The compaction density is a compaction density when the battery cell is in the fully-discharged state. The speed of transfer coating is 20 m/min. The hot pressing process includes three hot roller pressing stages with progressively increasing pressure. The hot roller pressures are sequentially 40 tons, 60 tons, and 80 tons. The hot rolling temperature is 60 °C. Prior to the first hot rolling compaction, the electrode plate is heated at a heating temperature of 40 °C.

The positive electrode plates were slit and punched into specified shapes. The punched positive electrode plates were then sorted by weight using a weight sorting machine for stacking by a stacking machine.

In the cross-section of the positive electrode film layer in the thickness direction of the electrode plate, in the area-weighted cumulative distribution curve of sphericity of the particles whose particle size R₁ meets R₁≥1000 nm, the median L_{R1A50} of sphericity is 0.689; the median C₅₀ of the graphitization degree of positive electrode film layer is 1.009; the median B₅₀ of the coating value B of the positive electrode film layer is 0.46; the iron dissolution rate of the positive electrode material is 974 ppm; based on the total area of the cross-section of the positive electrode film layer in the thickness direction of the electrode plate, the area percentage of the agglomeration regions of the conductive agent is 1.68%; and the porosity of the positive electrode film layer is 16.03%.

### (3) Manufacturing of a Negative Electrode Plate

The negative electrode slurry was prepared by homogeneously mixing a 1:1 mass ratio blend of artificial graphite and natural graphite, conductive agent (conductive carbon black), styrene-butadiene rubber (SBR) binder, and sodium carboxymethyl cellulose (CMC) thickener in the weight percentages of 96:0.5:2.0:1.5 in deionized water. After stirring and dispersion, the negative electrode slurry was coated onto a copper foil substrate. After drying, compaction, slitting, and tab formation, the negative electrode plate is obtained.

The negative electrode plates were slit and punched into specified shapes. The punched negative electrode plates were then sorted by weight using a weight sorting machine for stacking by a stacking machine.

### (4) Separator

Polyvinylidene fluoride (PVDF) was dissolved in N-methylpyrrolidone (NMP) and stirred uniformly, polyethylene glycol (PEG) was then added as a pore-forming agent, and after thorough stirring and mixing, a bonding layer solution was obtained. The bonding layer solution was coated onto the base film with ceramic coatings on both sides. After pre-volatilization at 80 °C and drying at 110 °C, the coated base film was immersed in deionized water to leach out the PEG, to obtain a separator with a bonding layer having a porous structure.

The thickness of the base film is 8 μm, the thickness of the single-side ceramic layer is 3 μm, and the thickness of the single-side bonding layer is 1 μm.

### (5) Electrolyte

Under argon atmosphere in a glove box (H₂O<0.1 ppm and O₂<0.1 ppm), organic solvents dimethyl carbonate (DMC), ethyl methyl carbonate (EMC), and ethylene carbonate (EC) were homogeneously mixed. Lithium hexafluorophosphate was then added and dissolved in the organic solvent to achieve a lithium hexafluorophosphate concentration of 1.05 mol/L, and vinylene carbonate (VC) was added and homogeneously stirred to obtain the electrolyte in Example 1. As calculated based on the total mass of the electrolyte, the mass content of dimethyl carbonate is 26%, the mass content of ethyl methyl carbonate is 43.3%, the mass content of ethylene carbonate is 17.3%, and the mass content of vinylene carbonate is 0.9%.

### (6) Manufacturing of a Battery

The positive electrode plate, the separator, and the negative electrode plate are stacked in sequence using the stacking machine. The separator needs to achieve the function of isolating the positive and negative electrodes to obtain the stacked electrode assembly. Taping treatment is performed on the stacked electrode assembly to tightly encapsulate the electrode assembly. The taped stacked electrode assembly was placed in an outer package. The outer package is made of an aluminum laminate film. The aluminum laminate film is a composite structure composed of an inner polypropylene layer, a middle aluminum foil layer, and an outer nylon layer. The outer package of the aluminum laminate film underwent processing via a pocket forming machine and trimming to obtain the target shape and dimensions. Subsequently, the aluminum laminate film was thermally encapsulated to meet the sealing strength of the aluminum laminate film ≥25 N/8 mm. The battery underwent vacuum baking and resting. Electrolyte was then injected via a blunt-tip needle, followed by encapsulation. Subsequently, the pouch-type battery underwent hot pressing and cold pressing operations. The hot pressing was performed at 45 °C for 2 minutes under a pressure of 90 kg/cm². The cold pressing was performed at 25 °C for 2 minutes under a pressure of 90 kg/cm²). Finally, after processes such as formation, degassing, trimming, and edge folding, the battery cell was obtained. The edge folding process is double edge folding. The battery cell has a dimension of 600 mm in the length direction, a dimension of 125 mm in the width direction, and a dimension of 20 mm in the thickness direction.

The manufacturing methods in Examples 2 to 5 are basically the same as the manufacturing method in Example 1, and a difference lies in that the method for manufacturing a positive electrode plate is adjusted, and details are as follows.

### Example 2

The positive electrode slurry in Example 1 was coated onto an aluminum foil for drying, the coating areal density was controlled by adjusting pressure magnitude, calendering speed, roller gap, dwell time, and the number of calendering passes in the hot pressing process, and hot pressing was performed to obtain a positive electrode plate with a single-side thickness of 70.45 μm and a positive electrode plate with a compaction density of 2.35 g/cm³ of the positive electrode film layer. The compaction density is a compaction density when the battery cell is in the fully-discharged state. The testing method thereof is provided below. The number of stacks is kept unchanged, and the thickness of the battery cell is adaptively adjusted based on the thickness of the positive electrode film layer.

### Example 3

The positive electrode slurry in Example 1 was coated onto an aluminum foil for drying, the coating areal density was controlled by adjusting pressure magnitude, calendering speed, roller gap, dwell time, and the number of calendering passes in the hot pressing process, and hot pressing was performed to obtain a positive electrode plate with a single-side thickness of 91.88 μm and a positive electrode plate with a compaction density of 2.36 g/cm³ of the positive electrode film layer. The compaction density is a compaction density when the battery cell is in the fully-discharged state. The testing method thereof is provided below. The number of stacks is kept unchanged, and the thickness of the battery cell is adaptively adjusted based on the thickness of the positive electrode film layer.

### Example 4

The positive electrode slurry in Example 1 was coated onto an aluminum foil for drying, the coating areal density was controlled by adjusting pressure magnitude, calendering speed, roller gap, dwell time, and the number of calendering passes in the hot pressing process, and hot pressing was performed to obtain a positive electrode plate with a single-side thickness of 119.49 μm and a positive electrode plate with a compaction density of 2.35 g/cm³ of the positive electrode film layer. The compaction density is a compaction density when the battery cell is in the fully-discharged state. The testing method thereof is provided below. The number of stacks is kept unchanged, and the thickness of the battery cell is adaptively adjusted based on the thickness of the positive electrode film layer.

### Example 5

The positive electrode slurry in Example 1 was coated onto an aluminum foil for drying, the coating areal density was controlled by adjusting pressure magnitude, calendering speed, roller gap, dwell time, and the number of calendering passes in the hot pressing process, and hot pressing was performed to obtain a positive electrode plate with a single-side thickness of 96.75 μm and a positive electrode plate with a compaction density of 2.55 g/cm³ of the positive electrode film layer. The compaction density is a compaction density when the battery cell is in the fully-discharged state. The testing method thereof is provided below. The number of stacks is kept unchanged, and the thickness of the battery cell is adaptively adjusted based on the thickness of the positive electrode film layer.

The manufacturing methods in Examples 6 and 7 are basically the same as the manufacturing method in Example 1, and a difference lies in that the method for manufacturing an electrolyte is adjusted, and details are as follows.

### Example 6

The proportions of the solvents in the electrolyte are adjusted, so that based on the total mass of the electrolyte, the mass percentage of dimethyl carbonate is 18%, the mass percentage of ethyl methyl carbonate is 47.3%, the mass percentage of ethylene carbonate is 21.3%, and the mass content of vinylene carbonate is 0.9%.

### Example 7

The proportions of the solvents in the electrolyte are adjusted, so that based on the total mass of the electrolyte, the mass percentage of dimethyl carbonate is 32%, the mass percentage of ethyl methyl carbonate is 40.3%, the mass percentage of ethylene carbonate is 14.3%, and the mass content of vinylene carbonate is 0.9%.

The manufacturing methods in Examples 8 to 12 are basically the same as the manufacturing method in Example 1, and a difference lies in that the methods for manufacturing a positive electrode active material and a positive electrode plate are adjusted, and details are as follows.

### Example 8

(1) Lithium dihydrogen phosphate, ferrous oxalate, polyethylene glycol with a weight-average molecular weight of 1000, polyethylene glycol with a weight-average molecular weight of 1600, titanium dioxide, and vanadium pentoxide were uniformly mixed and ground in methanol to obtain mixed raw materials. The ratio of lithium dihydrogen phosphate to ferrous oxalate was controlled to achieve a lithium-to-iron molar ratio of 1.025:1.0. The ferrous oxalate exhibits a particle size D₁₀=6.5 μm, a particle size D₅₀=62 μm, and a particle size D₉₀=108 μm. In the ferrous oxalate, the mass content of Fe is 30.5%, and the mass content of trivalent iron is 0.03%.

The mixed raw materials underwent multiple rounds of ball milling in a ball mill, followed by demagnetization to obtain the mixed slurry. The number of grinding cycles and grinding duration were controlled to achieve a particle size D₅₀ of 3.15 μm in the ground mixed slurry.

The mixed slurry was spray-dried to yield dried precursor powder, which exhibits a uniform light-yellow appearance.

The precursor powder was placed in a sintering furnace, was heated from 25 °C to 360 °C under nitrogen atmosphere at 2 °C/min and maintained at the temperature for 3.5 h, was then heated to a second temperature of 780 °C at 5 °C/min and maintained at the temperature for 10 h, and was cooled upon completion. Based on the total mass of the positive electrode active material, the mass content of Ti is 1050 ppm, and the mass content of vanadium is 950 ppm.

The obtained material was pulverized using an airflow pulverization method with a classification frequency of 21 Hz and a grinding air pressure of 0.54 MPa, yielding the positive electrode active material of lithium iron phosphate with a carbon material coated on the surface.

D₁₀, D₅₀, D₉₀, and Dᵥ₅₀ are data tested using a Malvern laser scattering method.

### (2) Manufacturing of a Positive Electrode Plate

The positive electrode active material, conductive agent, and polyvinylidene fluoride binder were mixed in a mass ratio of 95:2:3 using N-methylpyrrolidone as the solvent. The mixture was thoroughly blended, stirred, and dispersed in a stirring tank to form positive electrode slurry. Upon completion of the stirring process, the positive electrode slurry was transferred to the coating process. The stirring includes pre-mixing and main mixing. The stirring speed during the pre-mixing is lower than that during the main mixing. The pre-mixing was performed for 15 minutes with a revolution speed of 25 rpm and a rotation speed of 500 rpm. The conductive agent consists of conductive carbon black and multi-walled carbon nanotubes in a 1:1 mass ratio. The carbon black exhibits a specific surface area of 80 m²/g and an oil absorption value of 180 mL/100 g, and the carbon nanotubes have an average length of 20 μm and a specific surface area of 280 m²/g.

The positive electrode slurry was transfer-coated onto an aluminum foil for drying, and hot pressing is performed to obtain a positive electrode plate with a single-side thickness of 106.34 μm and a positive electrode plate with a compaction density of 2.35 g/cm³ of the positive electrode film layer. The compaction density is a compaction density when the battery cell is in the fully-discharged state.

The hot pressing process includes three hot roller pressing stages with progressively increasing pressure. The hot roller pressures are sequentially 35 tons, 55 tons, and 75 tons. The hot rolling temperature is 65 °C. Prior to the first hot rolling compaction, the electrode plate is heated at a heating temperature of 50 °C.

The positive electrode plates were slit and punched into specified shapes. The punched positive electrode plates were then sorted by weight using a weight sorting machine for stacking by a stacking machine.

### Example 9

### (1) Manufacturing of a Positive Electrode Active Material

Lithium carbonate, ferric phosphate, sucrose, glucose, titanium dioxide, and vanadium pentoxide were added to water and mixed in a premixing tank at a rotational speed of 1800 rpm. The ratio of lithium carbonate to ferric phosphate was controlled to achieve an iron-to-phosphorus molar ratio of 0.97. The mass content of glucose relative to ferric phosphate is 3.8%, and the mass content of sucrose relative to ferric phosphate is 1.9%.

The mixed raw materials underwent a two-stage grinding process in a sand mill: primary grinding using zirconium oxide balls with a diameter of 0.6 mm at a rotational speed of 500 rpm for grinding duration of 1 h with grinding cavity pressure less than 0.3 MPa, followed by secondary grinding to obtain mixed slurry. The particle size D₅₀ of the mixed slurry is 0.435 km.

The mixed slurry was spray-dried to obtain precursor powder.

The precursor powder was sintered to obtain the positive electrode material of lithium iron phosphate, and the sintering process includes:

Primary sintering: The precursor powder was sintered under nitrogen atmosphere. The temperature was raised from 25 °C to 765 °C at a heating rate of 5 °C/min and was maintained for 10 h. A primary sintering result was obtained after cooling.

Grinding and material mixing: Sucrose with a mass accounting for 0.5% of the total mass of the primary sintering result, glucose with a mass accounting for 1% of the total mass of the primary sintering result, and polyethylene glycol with a mass accounting for 3.0% of the total mass of the primary sintering result were added to the primary sintering result. The mixture was divided into two groups to perform grinding (tertiary grinding). Grinding (the grinding condition: 550 rpm, and the grinding duration: 1 h) stopped when D₅₀ of particles in the first group reached 1.02 μm to obtain a grinding result of the first group. Grinding (the grinding condition: 500 rpm, and the grinding duration: 4 h) stopped when D₅₀ of particles in the second group reached 0.42 m to obtain a grinding result of the second group. The grinding result of the first group and the grinding result of the second group were mixed in a mass ratio of 70:30 to obtain a mixed intermediate result. The mixed intermediate result was spray-dried.

Secondary sintering: The dried mixed intermediate result was sintered under nitrogen atmosphere. The temperature was raised from 25 °C to 800 °C at a heating rate of 5 °C/min and was maintained for 10 h. A secondary sintering result was obtained after cooling.

Upon completion of sintering, the mixture was cooled below 100 °C. The secondary sintering result was pulverized using an airflow pulverization method, yielding the positive electrode active material of lithium iron phosphate with a carbon material coated on the surface. A classification frequency of airflow pulverization is 23 Hz, and a grinding air pressure is 0.55 MPa. Based on the total mass of the positive electrode active material, the mass content of Ti is 1050 ppm, and the mass content of V is 950 ppm.

### (2) Manufacturing of a Positive Electrode Plate

The positive electrode active material, conductive agent, and polyvinylidene fluoride binder were mixed in a mass ratio of 95:2:3 using N-methylpyrrolidone as the solvent. The mixture was thoroughly blended, stirred, and dispersed in a stirring tank to form positive electrode slurry. Upon completion of the stirring process, the positive electrode slurry was transferred to the coating process. The stirring includes pre-mixing and main mixing. The stirring speed during the pre-mixing is lower than that during the main mixing. The pre-mixing was performed for 15 minutes with a revolution speed of 25 rpm and a rotation speed of 500 rpm. The conductive agent consists of conductive carbon black and multi-walled carbon nanotubes in a 1:1 mass ratio. The carbon black exhibits a specific surface area of 80 m²/g and an oil absorption value of 180 mL/100 g, and the carbon nanotubes have an average length of 20 μm and a specific surface area of 280 m²/g.

The positive electrode slurry was transfer-coated onto an aluminum foil for drying, and hot pressing is performed to obtain a positive electrode plate with a single-side thickness of 106.66 μm and a positive electrode plate with a compaction density of 2.36 g/cm³ of the positive electrode film layer. The compaction density is a compaction density when the battery cell is in the fully-discharged state. The drying temperature is 95 °C, and the speed is 2.0 m/min.

The hot pressing process includes three hot roller pressing stages with progressively increasing pressure. The hot roller pressures are sequentially 35 tons, 55 tons, and 75 tons. The hot rolling temperature is 65 °C. Prior to the first hot rolling compaction, the electrode plate is heated at a heating temperature of 50 °C.

The positive electrode plates were slit and punched into specified shapes. The punched positive electrode plates were then sorted by weight using a weight sorting machine for stacking by a stacking machine.

### Example 10

The manufacturing method in Example 10 is basically consistent with that in Example 1, and differences lie in that the process of manufacturing the positive electrode active material and the hot pressing process of the positive electrode plate are slightly different. Differences are specifically as follows.
(1) The carbon source in the mixed raw materials is sucrose and glucose. the mass of sucrose relative to the mass of ferric phosphate is 2 wt %, and the mass of glucose relative to the mass of ferric phosphate is 5.7 wt %.
(2) The sintering process is different. The precursor powder was sintered under nitrogen atmosphere at least twice. The sintering temperature of the first time is 750 °C, and the holding time is 8 hours, to obtain a preliminary sintering result.

1.5 wt % (based on the mass of the preliminary sintering result) of glucose, 3.0 wt % (based on the mass of the preliminary sintering result) of polyethylene glycol, titanium dioxide, and vanadium pentoxide were added to the preliminary sintering result. The mixture was ground uniformly and divided into two groups for secondary grinding. The two groups have different grinding parameters, the ground particles D₅₀ of the first group ware controlled to be 2.0 μm, and the ground particles D₅₀ of the second group were controlled to be 0.35 μm. The ground particles of the first group and the second group were mixed in a mass ratio of 30:70, and the mixture was spray-dried, and underwent secondary sintering. The temperature of the secondary sintering was 800 °C, and the temperature was held for 10 hours.

Based on the total mass of the positive electrode active material, the mass percentage of titanium was 1050 ppm, and the mass content of vanadium was 950 ppm.
(3) The positive electrode slurry was transfer-coated onto an aluminum foil for drying, and hot pressing is performed to obtain a positive electrode plate with a single-side thickness of 106.79 μm and a positive electrode plate with a compaction density of 2.36 g/cm³ of the positive electrode film layer. The compaction density is a compaction density when the battery cell is in the fully-discharged state. The drying temperature is 95 °C, and the speed is 2.0 m/min.

The hot pressing process includes three hot roller pressing stages with progressively increasing pressure. The hot roller pressures are sequentially 35 tons, 55 tons, and 70 tons. The hot rolling temperature is 65 °C. Prior to the first hot rolling compaction, the electrode plate is heated at a heating temperature of 50 °C.

### Example 11

The manufacturing method in Example 11 is basically consistent with that in Example 1, and differences lie in the process of sintering the positive electrode active material and the hot pressing process of the positive electrode plate. Specifically:
(1) The precursor powder underwent a two-stage sintering process under nitrogen atmosphere to obtain the positive electrode active material: In a first heating stage, the temperature was raised from 25 °C to 440 °C at a heating rate of 2 °C/min and maintained for 2.5 h. In a second heating stage, the temperature was raised from 440 °C to 760 °C at a heating rate of 5 °C/min and maintained for 11 h. The material was subjected to airflow pulverization to yield the positive electrode active material of lithium iron phosphate with a carbon material coated on the surface, exhibiting the particle size Dᵥ₅₀ of 1.6 μm. A classification frequency of airflow pulverization is 25 Hz, and a grinding air pressure is 0.55 MPa.
(2) The positive electrode slurry was transfer-coated onto an aluminum foil for drying, and hot pressing is performed to obtain a positive electrode plate with a single-side thickness of 106.10 μm and a compaction density of 2.35 g/cm³ of the positive electrode film layer. The compaction density is a compaction density when the battery cell is in the fully-discharged state. The speed of transfer coating is 20 m/min.

The hot pressing process includes three hot roller pressing stages with progressively increasing pressure. The hot roller pressures are sequentially 45 tons, 60 tons, and 80 tons. The hot rolling temperature is 60 °C. Prior to the first hot rolling compaction, the electrode plate is heated at a heating temperature of 40 °C.

### Example 11

The manufacturing method in Example 11 is similar to that in Example 8. A difference lies in that during the manufacturing of the positive electrode plate, after the positive electrode active material, conductive agent, and polyvinylidene fluoride binder were uniformly mixed in a mass ratio of 94.52:1.99:2.99 using N-methylpyrrolidone as the solvent, based on the total mass of the positive electrode active material, conductive agent, polyvinylidene fluoride binder, and dispersant, a dispersant HNBR with a mass percentage of 0.5% was added, and the mixture was thoroughly blended, stirred, and dispersed in the stirring tank to form positive electrode slurry.

### Example 12

The manufacturing method in Example 12 is similar to that in Example 11. A difference lies in that during the manufacturing of the positive electrode plate, after the positive electrode active material, conductive agent, and polyvinylidene fluoride binder were uniformly mixed in a mass ratio of 93.57:1.97:2.96 using N-methylpyrrolidone as the solvent, based on the total mass of the positive electrode active material, conductive agent, polyvinylidene fluoride binder, and dispersant, a dispersant HNBR with a mass percentage of 1.5% was added.

The manufacturing method in Example 13 is basically the same as that in Example 1, and a difference lies in that the method for manufacturing a positive electrode plate is adjusted, and details are as follows.

### Example 13

The conductive agent used in Example 12 includes conductive carbon black with a mass percentage of 2% and does not include carbon nanotubes. The carbon black exhibits a specific surface area of 85 m²/g and an oil absorption value of 200 mL/100 g.

The manufacturing method in Comparative Example 1 is basically consistent with that in Example 1, and a difference lies in the process of manufacturing the battery. Specifically:

In Comparative Example 1, the edge folding process is single edge folding.

The manufacturing methods in Examples 2 and 3 are basically consistent with the manufacturing method in Example 1, and a difference lies in that the method for manufacturing a positive electrode plate is adjusted, and details are as follows.

### Comparative Example 2

The positive electrode slurry in Example 1 was coated onto an aluminum foil for drying, the coating areal density was controlled by adjusting pressure magnitude, calendering speed, roller gap, dwell time, and the number of calendering passes in the hot pressing process, and hot pressing was performed to obtain a positive electrode plate with a single-side thickness of 65.08 μm and a compaction density of 2.35 g/cm³ of the positive electrode film layer. The compaction density is a compaction density when the battery cell is in the fully-discharged state. The testing method thereof is provided below. The number of stacks is kept unchanged, and the thickness of the battery cell is adaptively adjusted based on the thickness of the positive electrode film layer.

### Comparative Example 3

The positive electrode slurry in Example 1 was coated onto an aluminum foil for drying, the coating areal density was controlled by adjusting pressure magnitude, calendering speed, roller gap, dwell time, and the number of calendering passes in the hot pressing process, and hot pressing was performed to obtain a positive electrode plate with a single-side thickness of 125.64 μm and a compaction density of 2.52 g/cm³ of the positive electrode film layer. The compaction density is a compaction density when the battery cell is in the fully-discharged state. The testing method thereof is provided below. The number of stacks is kept unchanged, and the thickness of the battery cell is adaptively adjusted based on the thickness of the positive electrode film layer.

The manufacturing method in Comparative Example 4 is basically the same as that in Example 1, and a difference lies in that the method for manufacturing an electrolyte is adjusted, and details are as follows.

### Comparative Example 4

The proportions of the solvents in the electrolyte are adjusted, so that based on the total mass of the electrolyte, the mass percentage of dimethyl carbonate is 36%, the mass percentage of ethyl methyl carbonate is 38.3%, the mass percentage of ethylene carbonate is 12.3%, and the mass content of vinylene carbonate is 0.9%.

The manufacturing method in Comparative Example 5 is basically the same as the manufacturing method in Example 1, and a difference lies in that the method for manufacturing a positive electrode active material is adjusted, and details are as follows.

### Comparative Example 5

The precursor powder underwent a two-stage sintering process under nitrogen atmosphere to obtain the positive electrode active material: In a first heating stage, the temperature was raised from 25 °C to 500 °C at a heating rate of 2 °C/min and maintained for 3.5 h. In a second heating stage, the temperature was raised from 500 °C to 800 °C at a heating rate of 5 °C/min and maintained for 13 h. The material was subjected to airflow pulverization to yield the positive electrode active material of lithium iron phosphate with a carbon material coated on the surface, exhibiting the particle size Dᵥ₅₀ of 1.6 μm. A classification frequency of airflow pulverization is 25 Hz, and a grinding air pressure is 0.55 MPa.

### Test Methods:

### 1. Compaction Density Test of the Electrode Plate (Fully-Discharged)

The battery cell is placed in a 25 °C oven environment and is rested for 2 h. When the temperature of the battery maintains 25 °C, the battery is discharged to 2.0 V at a ⅓C constant current. The battery is disassembled to obtain the positive electrode plate. The residual electrolyte is processed using a dimethyl carbonate solvent. The electrode plate is dried, and is cut into a disc with an area of S. It is obtained that the mass of the disc is W₁, and the thickness T₁ of the positive electrode plate is measured using a ten-thousandth micrometer. The positive electrode film layer of the foregoing weighed electrode plate is then wiped off. The mass of the current collector is weighed and denoted as W₂, and the thickness T₂ of the current collector is measured using the ten-thousandth micrometer. The compaction density of the positive electrode film layer PD=(W₁−W₂)/[(T₁−T₂)×S].

### 2. Springback Rate Test

The initial single-side thickness of the positive electrode film layer was measured for the compacted positive electrode plate using a laser thickness tester, and is denoted as T0 in μm. The positive electrode plate was combined with other parts and processed into the battery cell. At 25 °C, the battery cell is charged at a charging rate of 0.5 C based on the nominal capacity until the voltage reaches 3.65 V, followed by constant-voltage charging at 3.65 V until the current drops to 0.05 C. After a 10-minute rest, the battery is discharged at a discharging rate of 1 C until the voltage drops to 2.5 V, followed by another 10-minute rest. The charging and discharging is one cycle. After 100 cycles, the battery cell was disassembled to obtain the positive electrode plate, followed by a 1-h rest. The single-side thickness of the positive electrode film layer after the cycles was measured using a laser thickness tester, and is denoted as T1 in m.

The springback rate of the battery cell was calculated: Springback Rate=(T1−T0)/T0×100%.

### 3. Gas Generation Amount Test

At 25 °C, the battery cell is charged at a charging rate of 0.5 C based on the nominal capacity until the voltage reaches 3.65 V, followed by constant-voltage charging at 3.65 V until the current drops to 0.05 C. After a 10-minute rest, the battery is discharged at a discharging rate of 1 C until the voltage drops to 2.5 V, followed by another 10-minute rest. The initial thickness (T2) of the battery cell in m was measured using the laser thickness tester at 25 °C. The charging and discharging is one cycle. After 100 cycles, the battery cell was rested for 1 h. The thickness (T3) of the battery cell in m after the cycles was measured using the laser thickness tester. The gas generation amount of the battery cell was measured: Gas Generation Amount=(T3−T2)/T2×100%.

In accordance with the above methods, the battery cells in the examples and comparative examples were prepared. Specific parameters and performance are shown in the tables below.

TABLE 1

| | | | | | Positive electrode plate | | | | |
|---|---|---|---|---|---|---|---|---|---|
| | | | | | | Area | | | |
| | | | | | Single- | percentage | Fully- | | |
| | | | | | side | of | discharged | | |
| | | | | | thickness | particles | state, | | |
| | | | | | of a | whose | compaction | | |
| | | Electrolyte | | | positive | particle size | density of the | | |
| | | Content | Content | Content | electrode | R1 meets R1 | positive | | Gas |
| | Folded | of DMC/ | of EMC/ | of EC/ | film layer | ≥1000 nm/ | electrode | Springback | generation |
| | edge | % | % | % | μm | % | plate g/cm³ | rate⁽¹⁾ | amount⁽²⁾ |
| Example 1 | Double- | 26 | 43.3 | 17.3 | 106.09 | 36.83 | 2.35 | Small | Small |
| | folded | | | | | | | | |
| | edge | | | | | | | | |
| Example 2 | Double- | 26 | 43.3 | 17.3 | 70.45 | 36.75 | 2.35 | Small | Small |
| | folded | | | | | | | | |
| | edge | | | | | | | | |
| Example 3 | Double- | 26 | 43.3 | 17.3 | 91.88 | 38.09 | 2.36 | Small | Small |
| | folded | | | | | | | | |
| | edge | | | | | | | | |
| Example 4 | Double- | 26 | 43.3 | 17.3 | 119.49 | 36.92 | 2.35 | Medium | Small |
| | folded | | | | | | | | |
| | edge | | | | | | | | |
| Example 5 | Double- | 26 | 43.3 | 17.3 | 96.75 | 36.95 | 2.55 | Medium | Small |
| | folded | | | | | | | | |
| | edge | | | | | | | | |
| Example 6 | Double- | 18 | 47.3 | 21.3 | 106.10 | 36.89 | 2.35 | Small | Small |
| | folded | | | | | | | | |
| | edge | | | | | | | | |
| Example 7 | Double- | 32 | 40.3 | 14.3 | 106.02 | 36.71 | 2.35 | Small | Medium |
| | folded | | | | | | | | |
| | edge | | | | | | | | |
| Example 8 | Double- | 26 | 43.3 | 17.3 | 106.34 | 34.89 | 2.35 | Small | Small |
| | folded | | | | | | | | |
| | edge | | | | | | | | |
| Example 9 | Double- | 26 | 43.3 | 17.3 | 106.66 | 34.97 | 2.36 | Small | Small |
| | folded | | | | | | | | |
| | edge | | | | | | | | |
| Example 10 | Double- | 26 | 43.3 | 17.3 | 106.79 | 49.99 | 2.36 | Medium | Small |
| | folded | | | | | | | | |
| | edge | | | | | | | | |
| Example 11 | Double- | 26 | 43.3 | 17.3 | 106.10 | 12.11 | 2.35 | Small | Small |
| | folded | | | | | | | | |
| | edge | | | | | | | | |
| Comparative | Single- | 26 | 43.3 | 17.3 | 105.64 | 36.64 | 2.35 | / | / |
| Example 1 | folded | | | | | | | | |
| | edge | | | | | | | | |
| Comparative | Double- | 26 | 43.3 | 17.3 | 65.08 | 36.70 | 2.35 | Small | Small |
| Example 2 | folded | | | | | | | | |
| | edge | | | | | | | | |
| Comparative | Double- | 26 | 43.3 | 17.3 | 125.64 | 36.90 | 2.52 | Large | Small |
| Example 3 | folded | | | | | | | | |
| | edge | | | | | | | | |
| Comparative | Double- | 36 | 38.3 | 12.3 | 105.64 | 36.64 | 2.35 | Small | Large |
| Example 4 | folded | | | | | | | | |
| | edge | | | | | | | | |
| Comparative | Double- | 26 | 43.3 | 17.3 | 106.79 | 56.75% | 2.36 | Large | Small |
| Example 5 | folded | | | | | | | | |
| | edge | | | | | | | | |

⁽¹⁾Small: the springback rate is below 2%; middle: the springback rate ranges from 2% to 5% (excluding 2%); and large: the springback rate is above 5% (excluding 5%).
⁽²⁾Small: the gas generation amount is below 1.5%; middle: the gas generation amount ranges from 1.5% to 2% (excluding 1.5%); and large: the gas generation amount is above 2% (excluding 2%).

In Comparative Example 1, only a single-folded first sealing zone is disposed, and encapsulation fails during long-term cycling, exhibiting poor reliability. In Comparative Example 2, the thickness of the positive electrode film layer is small, the occupation of space of the positive electrode active material is low, and the capacity of the battery cell is low. In Comparative Example 3, the thickness of the positive electrode film layer is excessively large, the springback is severe, and the pressure in the sealing zone is increased, affecting the long-term reliability of the battery cell. In Comparative Example 4, the electrolyte has an excessively large content of DMC and is prone to gas generation, which causes an increase in the pressure inside the battery cell to cause an encapsulation failure, leading to reduced reliability of the battery cell. In Comparative Example 5, the area percentage of the particles whose particle size R1 meets R1≥1000 nm is excessively large, the springback of the positive electrode film layer is severe, and the sealing zone of the battery cell is highly prone to a failure.

Referring to FIG. 1, the battery cell in the embodiments of this application is specifically described as follows:

A battery cell includes a stacked electrode assembly and a housing, where the stacked electrode assembly is accommodated in the housing, and the housing is made of a pouch-type material; the housing includes a first sealing zone, and the first sealing zone is disposed at at least one end of the stacked electrode assembly extending along a width direction; the first sealing zone includes a double-folded edge structure extending along a length direction, a sealing adhesive is disposed on the double-folded edge structure, and the sealing adhesive is continuously disposed in the length direction and secures the double-folded edge structure; the stacked electrode assembly includes a positive electrode plate, a negative electrode plate, and an electrolyte, the positive electrode plate includes a positive electrode current collector and a positive electrode film layer disposed on at least one side of the positive electrode current collector, the positive electrode film layer includes lithium-containing transition metal phosphate particles, and at least a portion of a surface of the lithium-containing transition metal phosphate particles is provided with a carbon material; based on a total area of particles in a cross-section of the positive electrode film layer in a thickness direction of the positive electrode plate, an area percentage of particles whose particle size R1 meets R1≥1000 nm ranges from 12% to 50%; a single-side thickness of the positive electrode film layer is denoted as H, and H ranges from 70 μm to 120 m; when the battery cell is in a fully-discharged state, a compaction density of the positive electrode plate ranges from 2.3 g/cm³ to 2.6 g/cm³; and the electrolyte includes a solvent, and the solvent includes dimethyl carbonate (DMC); and based on a total mass of the electrolyte, a mass percentage of dimethyl carbonate ranges from 18% to 32%.

In this way, the stacked electrode assembly, the large thickness of the positive electrode film layer, the high compaction density, and the large area percentage of the particles with the particle size R1 increase the capacity and energy density of the battery cell, and the combination of the double-folded edge structure and the sealing adhesive of the first sealing zone, so that the mechanical strength of the sealing zone can be significantly improved, thereby reducing the possibility that the sealing of the battery cell fails due to internal pressure during long cycling.

As can be seen from Examples 1, 8, 9, and 11 and Example 10, when the area percentage of particles whose particle size R1 meets R1≥1000 nm based on the total area of particles in the cross-section of the positive electrode film layer in the thickness direction of the positive electrode plate ranges from 12% to 40%, the springback rate is further reduced, thereby improving the long-term reliability of the battery cell.

TABLE 2

| | | Distribution | | | Single- | Fully- | | |
|---|---|---|---|---|---|---|---|---|
| | | uniformity | | | side | discharged | | |
| | | of particles | | | thickness | state, | | |
| | | whose | | | of a | compaction | | |
| | | particle size | | | positive | density of the | | |
| | | R1 meets | Graphitization | Coating | electrode | positive | | Gas |
| | | R1 ≥ 1000 | degree | value | film layer | electrode plate | Springback | generation |
| | L_{R1A50} | nm/% | C₅₀ | B₅₀ | μm | g/cm³ | rate⁽¹⁾ | amount⁽²⁾ |
| Example | 0.687 | 1.90 | 1.00 | 0.369 | 105.64 | 2.36 | Small | Small |
| 1 | | | | | | | | |
| Example | 0.673 | 0.99 | 1.02 | 0.446 | 105.89 | 2.36 | Small | Small |
| 8 | | | | | | | | |
| Example | 0.745 | 1.47 | 1.04 | 0.368 | 106.21 | 2.37 | Small | Small |
| 9 | | | | | | | | |
| Example | 0.72 | 4.91 | 1.02 | 0.456 | 106.34 | 2.37 | Medium | Small |
| 10 | | | | | | | | |
| Example | 0.75 | 1.82 | 0.98 | 0.355 | 105.65 | 2.36 | Small | Small |
| 11 | | | | | | | | |

⁽¹⁾Small: the springback rate is below 2%; middle: the springback rate ranges from 2% to 5% (excluding 2%); and large: the springback rate is above 5% (excluding 5%).
⁽²⁾Small: the gas generation amount is below 1.5%; middle: the gas generation amount ranges from 1.5% to 2% (excluding 1.5%); and large: the gas generation amount is above 2% (excluding 2%).

As can be seen from Examples 1 and 8-11, based on the total area of particles in the cross-section of the positive electrode film layer in the thickness direction of the positive electrode plate, in the area-weighted cumulative distribution curve of sphericity of particles whose particle size R1 meets R1≥1000 nm, the median L_{R1A50} of sphericity ranges from 0.6 to 0.8. When the distribution uniformity of the particles whose particle size R1 meets R1≥1000 nm is less than or equal to 5%, the battery cell exhibits a small springback rate and a small gas generation amount. In the area-weighted cumulative distribution curve of sphericity of particles whose particle size R1 meets R1≥1000 nm, the median L_{R1A50} of sphericity ranges from 0.67 to 0.75. The distribution uniformity of the particles whose particle size R1 meets R1≥1000 nm falls within the range of 0.2% to 2%, thereby further improving the long cycle stability of the battery.

TABLE 3

| | | | Distribution | |
|---|---|---|---|---|
| | | | uniformity of | |
| | | | particles whose | |
| | Type | Content | particle size | |
| | of the | of the | R1 meets R1 ≥ | Springback |
| | dispersant | dispersant | 1000 nm/% | rate(1) |
| Example 8 | / | / | 0.99 | Small |
| Example | HNBR | 0.5% | 0.45 | Small |
| 11 | | | | |
| Example | HNBR | 1.5% | 0.24 | Small |
| 12 | | | | |

(1)Small: the springback rate is below 2%; middle: the springback rate ranges from 2% to 5% (excluding 2%); and large: the springback rate is above 5% (excluding 5%).

As can be seen from Examples 8, 11, and 12, the distribution uniformity of the particles whose particle size R1 meets R1≥1000 nm falls within the range of 0.2% to 0.9%, which is conducive to further reducing the degree stress concentration and mitigating the springback of the positive electrode film layer, thereby improving the long cycle stability of the battery.

TABLE 4

| | Content of CNT | Springback rate(1) |
|---|---|---|
| Example 1 | 0.67% | Small |
| Example | 0% | Medium |
| 13 | | |

(1)Small: the springback rate is below 2%; middle: the springback rate ranges from 2% to 5% (excluding 2%); and large: the springback rate is above 5% (excluding 5%).

As can be seen from the comparison between Example 1 and Example 13, the conductive agent includes carbon nanotubes, and the mass content C1 of the carbon nanotubes meets 0<C1≤2.5%, which is conducive to mitigating springback of the positive electrode film layer during cycling, thereby improving the long-term reliability of the battery.

It should be noted that this application is not limited to the embodiments above. The foregoing implementations are exemplary only, and any implementation within the scope of the technical solution of this application that has substantially the same composition and has the same effects as the technical idea is encompassed in the technical scope of this application. In addition, without departing from the scope of the gist of this application, various modifications that can be conceived by those skilled in the art and applied to the implementations, and other modes constructed by combining some of the components in the implementations are also encompassed in the scope of this application.

1. A battery cell, comprising a stacked electrode assembly and a housing, wherein the stacked electrode assembly is accommodated in the housing, and the housing is made of a pouch-type material; the housing comprises a first sealing zone, and the first sealing zone is disposed at at least one end of the stacked electrode assembly extending along a width direction; the first sealing zone comprises a double-folded edge structure extending along a length direction, a sealing adhesive is disposed on the double-folded edge structure, and the sealing adhesive is continuously disposed in the length direction and secures the double-folded edge structure, the housing further comprises at least one second sealing zone, the second sealing zone is disposed at at least one end of the stacked electrode assembly in the length direction of the housing, and the second sealing zone is disposed on a tab side of the stacked electrode assembly;
the stacked electrode assembly comprises a positive electrode plate, a negative electrode plate, and an electrolyte, the positive electrode plate comprises a positive electrode current collector and a positive electrode film layer disposed on at least one side of the positive electrode current collector, the positive electrode film layer comprises lithium-containing transition metal phosphate particles, and at least a portion of a surface of the lithium-containing transition metal phosphate particles is provided with a carbon material;
based on a total area of particles in a cross-section of the positive electrode film layer in a thickness direction of the positive electrode plate, an area percentage of particles whose particle size R1 meets R1≥1000 nm ranges from 12% to 50%;
a single-side thickness of the positive electrode film layer is denoted as H, and H ranges from 70 μm to 120 μm;
when the battery cell is in a fully-discharged state, a compaction density of the positive electrode plate ranges from 2.3 g/cm³ to 2.6 g/cm³; and
the electrolyte comprises a solvent, and the solvent comprises dimethyl carbonate (DMC), ethylene carbonate (EC), and ethyl methyl carbonate (EMC); and based on a total mass of the electrolyte, a mass percentage of dimethyl carbonate (DMC) ranges from 18% to 32%, a mass percentage of ethylene carbonate (EC) ranges from 13% to 22%, a mass percentage of ethyl methyl carbonate (EMC) ranges from 39% to 49%,
wherein, in the cross-section of the positive electrode film layer in the thickness direction of the positive electrode plate, a distribution uniformity of particles whose particle size R1 meets R1≥1000 nm ranges from 0.2% to 2%;
wherein, in the cross-section of the positive electrode film layer in the thickness direction of the positive electrode plate, in an area-weighted cumulative distribution curve of sphericity of particles whose particle size R1 meets R1≥1000 nm, a median L (L_{R1A50}) of sphericity ranges from 0.6 to 0.8;
wherein, in a cumulative distribution curve of a graphitization degree C value obtained from the positive electrode film layer in an area mapping mode of a laser microscopic confocal Raman spectrometer, a median C₅₀ of the graphitization degree C ranges from 0.95 to 1.20, the graphitization degree C value is I_{G}/I_{D}, I_{G} represents an intensity of a G band at 1580±100 cm⁻¹ in Raman spectra, and I_{D} represents an intensity of a D band at 1350±100 cm⁻¹ in Raman spectra;
wherein, in a cumulative distribution curve of a coating value B obtained from the positive electrode film layer in the area mapping mode of the laser microscopic confocal Raman spectrometer, a median B₅₀ of the coating value B ranges from 0.30 to 0.60, the coating value B is I_{P}/I_{D}, I_{P} represents an intensity of a P band at 948±100 cm⁻¹ in Raman spectra.

2. The battery cell according to claim 1, wherein the single-side thickness of the positive electrode film layer is denoted as H, and H ranges from 90 μm to 120 μm,
based on the total area of particles in the cross-section of the positive electrode film layer in the thickness direction of the positive electrode plate, the area percentage of particles whose particle size R1 meets R1≥1000 nm ranges from 12% to 37%,
in the cross-section of the positive electrode film layer in the thickness direction of the positive electrode plate, in an area-weighted cumulative distribution curve of sphericity of particles whose particle size R1 meets R1≥1000 nm, a median L_{R1A50} of sphericity ranges from 0.65 to 0.75.

3. (canceled)

4. The battery cell according to claim 1, wherein the first sealing zone and the second sealing zone are different sealing zones disposed on different sides of the housing, the second sealing zone is not a portion of the first sealing zone, and the battery cell further comprises a terminal connected to a tab of the battery cell and at least partially located outside the housing, the second sealing zone being disposed on a side of the housing on which the terminal is located:
wherein an outer periphery of the stacked electrode assembly is provided with a plurality of adhesive rings surrounding along the width direction, and the adhesive rings surrounding along the width direction are disposed at intervals in the length direction.

5-7. (canceled)

8. The battery cell according to claim 1, wherein
the electrolyte comprises an electrolyte salt, the electrolyte salt comprises lithium hexafluorophosphate (LiPF₆), and a concentration of lithium hexafluorophosphate in the electrolyte ranges from 0.9 mol/L to 1.2 mol/L.

9-10. (canceled)

11. The battery cell according to claim 1, wherein the lithium-containing transition metal phosphate particles comprise iron, and an iron dissolution rate of the positive electrode film layer ranges from 700 ppm to 1921 ppm.

12. The battery cell according to claim 1, wherein the positive electrode film layer further comprises a conductive agent, and based on a total area of the cross-section of the positive electrode film layer in the thickness direction of the positive electrode plate, a total area percentage of agglomeration regions of the conductive agent ranges from 0.5% to 2.5%, wherein
the conductive agent comprises carbon nanotubes, and the carbon nanotubes comprise one or more of single-walled carbon nanotubes, few-walled carbon nanotubes, and multi-walled carbon nanotubes;
the agglomeration regions of the conductive agent comprise carbon nanotubes and conductive carbon black, wherein based on a mass of the positive electrode film layer, a mass content C1 of the carbon nanotubes meets: 0<C1≤2.5%, and a mass content C2 of the conductive carbon black meets: 0<C2≤2.5%.

13. The battery cell according to claim 1, wherein
the positive electrode film layer further comprises a dispersant, and the dispersant comprises hydrogenated nitrile butadiene rubber HNBR, wherein based on the mass of the positive electrode film layer, a mass content of the dispersant ranges from 0.5% to 2%;
a porosity of the positive electrode film layer ranges from 14% to 24%.

14. The battery cell according to claim 1, wherein the battery cell further comprises a separator disposed between the positive electrode plate and the negative electrode plate, the separator comprises a base film, a respective ceramic layer disposed on each of two sides of the base film, and a respective bonding layer disposed on each ceramic layer away from the base film, each bonding layer is a continuous layer with a porous structure, and the bonding layer comprises a vinylidene fluoride-based polymer.

15. The battery cell according to claim 1, wherein a base coating layer is disposed in a bottom region of the positive electrode film layer close to the positive electrode current collector, and the base coating layer meets at least one of the following conditions:
(1) the base coating layer comprises a conductive agent and a binder, the conductive agent comprises carbon nanotubes and conductive carbon black, and the binder comprises a vinylidene fluoride polymer; and
(2) a thickness of the base coating layer ranges from 0.5 μm to 5 km.

16. The battery cell according to claim 1, wherein the lithium-containing transition metal phosphate particles in the positive electrode film layer comprise a component shown in the following general formula:
LiₘFeₓP_{y}OⱼQ_{q} Formula I,
wherein Q comprises one or more of Al, Na, K, Mg, Cu, Mn, Cr, Zn, Pb, Ca, Co, Ni, Sr, Nb, V, Ti, B, S, Si, N, F, Cl, and Br, 0.8≤m≤1.15, 0.9≤x≤1, 0.95≤y≤1, 3.5≤j≤4, and 0≤q≤0.1.

17. The battery cell according to claim 1, wherein
the lithium-containing transition metal phosphate particles comprise titanium, and based on a total mass of the lithium-containing transition metal phosphate particles in the positive electrode film layer, a mass content of titanium ranges from 500 ppm to 8000 ppm;
the lithium-containing transition metal phosphate particles comprise vanadium, and based on the total mass of the lithium-containing transition metal phosphate particles in the positive electrode film layer, a mass content of vanadium ranges from 500 ppm to 5000 ppm;
at least one stacked electrode assembly is accommodated in the housing, a dimension of the housing in the length direction is L₀, a dimension of the housing in the width direction is W₀, a dimension of the housing in the thickness direction is H₀, 450 mm L₀≤1300 mm, 100 mm≤W₀≤150 mm, and 14 mm≤H₀≤22 mm, wherein a dimension L₀ of the housing in the length direction meets: 450 mm≤L₀≤650 mm and/or the dimension L₀ of the housing in the length direction meets: 900 mm≤L₀≤1300 mm.

18. The battery cell according to claim 1, wherein at 25 °C, a capacity of the battery cell ranges from 105 Ah to 300 Ah.

19. A battery apparatus, comprising the battery cell according to claim 1.

20. A power consuming apparatus, wherein the power consuming apparatus comprises the battery apparatus according to claim 19, and the battery apparatus is configured to supply electric energy.

21. The battery cell according to claim 1, wherein the positive electrode film layer further comprises a conductive agent comprising carbon nanotubes and conductive carbon black, and, based on a total area of the cross-section of the positive electrode film layer in the thickness direction of the positive electrode plate, an area percentage of agglomeration regions of the conductive agent ranges from 0.5% to 1.7%, wherein the area percentage is a mean of area percentages measured from three randomly selected, nonoverlapping scanning electron micrographs at a magnification of 3,000, and each agglomeration region is a black region having a Feret diameter greater than or equal to 2 μm.

22. The battery cell according to claim 17, wherein, based on a total mass of the carbon-coated lithium iron phosphate, the mass content of titanium ranges from 500 ppm to 1,500 ppm and a mass content of vanadium ranges from 500 ppm to 1,500 ppm.

23. The battery cell according to claim 17, wherein at least one stacked electrode assembly is accommodated in the housing, a dimension of the housing in the length direction is L₀, and 900 mm≤L₀≤1,300 mm.

24. The battery cell according to claim 1, wherein the pouch-type material is an aluminum laminate film comprising an inner polypropylene layer, a middle aluminum-foil layer, and an outer nylon layer, and a sealing strength of the aluminum laminate film is greater than or equal to 25 N/8 mm.

25. The battery cell according to claim 1, wherein for each of the graphitization degree C value and the coating value B, the laser microscopic confocal Raman spectrometer uses a 532 nm excitation wavelength to area-map a 45 m×45 μm region of a cross-section of the positive electrode film layer, the region is divided into a 10×10 grid with a step size of 5 μm to obtain 100 scan points, at least 100 obtained values are sorted in ascending order to form the respective cumulative distribution curve, and the respective median C₅₀ or B₅₀ is the value at a cumulative number percentage of 50%,
wherein, to determine the distribution uniformity, the cross-section of the positive electrode film layer is divided in the thickness direction into a lower layer, a middle layer, and an upper layer having equal thicknesses, multiple nonoverlapping scanning electron micrographs are randomly obtained from each of the lower, middle, and upper layers, an area percentage of particles whose particle size R1 meets R1≥1000 nm is determined in each of the multiple scanning electron micrographs, and the distribution uniformity is a difference between a largest one and a smallest one of the area percentages.
